(19) United States
(12) Patent Application Publication
(10) Pub. No.: US 2026/0005979 A1
(43) Pub. Date: Jan. 1, 2026

(54) NETWORK-ASSISTED DELIVERY OF HTTP TRANSPORT

(71) Applicant: Adeia Guides Inc., San Jose, CA (US)

(72) Inventors: Dhananjay Lal, Englewood, CO (US); Christopher Phillips, Hartwell, GA (US); Reda Harb, Tampa, FL (US); Serhad Doken, Bryn Mawr, PA (US)

(21) Appl. No.: 18/756,163

(22) Filed: Jun. 27, 2024

(51) Int. Cl. H04L 47/62; H04L 47/24

(52) U.S. Cl. CPC H04L 47/6215; H04L 47/24

(57) ABSTRACT

Systems and methods are provided for receiving, from a client device over a network, a first urgency parameter in relation to a first portion of a network resource, wherein networking equipment associated with the network provides a first queue for preferential network traffic and a second queue for non-preferential network traffic; identifying, by a server, a second urgency parameter in relation to the first portion of the network resource; based on at least one of the first urgency parameter or the second urgency parameter, determining whether to transmit the first portion to the client device over the network using the first queue or the second queue; and based on the determining, causing the first portion of the network resource to be transmitted preferentially to the client device over the network using the first queue instead of the second queue.

### CROSS-REFERENCE TO RELATED APPLICATIONS

The disclosure of commonly owned application Ser. No. 18/626,668, filed Apr. 4, 2024, and entitled “CUSTOMER-CENTRIC, APPLICATION-FLOW AWARE BROADBAND SERVICE,” (Attorney docket no. 003597-2998-101) is hereby incorporated by reference herein in its entirety. The disclosure of commonly owned application Ser. No. 18/626,659, filed Apr. 4, 2024, and entitled “APPLICATION FLOW-AWARE BROADBAND SERVICE WITH DATA CAPS,” (Attorney docket no. 003597-4007-101) is hereby incorporated by reference herein in its entirety. The disclosure of commonly owned application Ser. No. 18/667,655, filed May 17, 2024, and entitled “INTELLIGENT APPLICATION PRIORITY PACKET DELIVERY CONTROL,” (Attorney docket no. 003597-4018-101) is hereby incorporated by reference herein in its entirety. The disclosure of commonly owned application Ser. No. 18/744,496, filed Jun. 14, 2024, and entitled “DYNAMIC SYSTEMS AND METHODS FOR MEDIA-AWARE LOW-TO ULTRALOW-LATENCY, REAL-TIME TRANSPORT PROTOCOL CONTENT DELIVERY,” (Attorney docket no. 003597-4029-101) is hereby incorporated by reference herein in its entirety. The disclosure of commonly owned application Ser. No. 18/744,547, filed Jun. 14, 2024, and entitled “DYNAMIC SYSTEMS AND METHODS FOR MEDIA-AWARE TRANSPORT OF FRAGMENT OF CONTENT IN LOW-LATENCY, OVER-THE-TOP, AND ADAPTIVE BITRATE STREAMING,” (Attorney docket no. 003597-4033-101) is hereby incorporated by reference herein in its entirety. The disclosure of commonly owned Application No. ______, filed Jun. 27, 2024, and entitled “OPTIMIZED DELIVERY FOR SPHERICAL MEDIA CONTENT,” (Attorney docket no. 003597-4054-101) is hereby incorporated by reference herein in its entirety.

### BACKGROUND

This disclosure is directed to systems and methods for using priority parameters for treating portions of a network resource preferentially, e.g., using Low Latency, Low Loss, and Scalable Throughput (L4S).

### SUMMARY

Hypertext Transfer Protocol (HTTP) is an Internet standard that supports information exchange on the World Wide Web (WWW), including defining uniform resource locators (URLs) and how they can be used to retrieve resources on the Internet, and embedding hyperlinks in Hypertext Markup Language (HTML) documents. Selection of a link by a user initiates a data transfer process, transparent to the user, that accesses and retrieves a document.

An HTTP resource typically has a relationship to one or more resources that comprise the whole, and these resources may lie on the same server as the HTTP resource, or they may be distributed in the cloud/content delivery network (CDN). Consider, for example, an HTML document that is requested by a client. The rendering of this document may be blocked by the retrieval of a cascading style sheets (CSS) file that is referred to be the document. Another example is a “hero image,” i.e., an image that is central to a webpage. In this example, while the image is extremely important, it may be inline, so the client may not be blocked in rendering the webpage. The image is drawn incrementally as portions of that image arrive. Clients discover these relationships while processing a retrieved representation, which may lead to further retrieval requests.

A stream is a sequence of bytes delivered from a sender to a receiver. HTTP/1.1 allowed multiple requests and responses to use the same TCP connection, however these had to be served sequentially. HTTP/2 introduced multiplexing, which allowed multiple requests to be served concurrently over a single TCP connection. However, due to the properties of TCP, Head-of-line (HoL) blocking could still occur such that the response of one request could be adversely affected by another request's response since both request-responses are on a connection with unified congestion control and flow control. HTTP/3 replaced transmission control protocol (TCP) with QUIC, reducing overhead and enhancing efficiency. With QUIC, each stream can have independent congestion control and flow control. Since an arbitrary number of streams can be opened between the endpoints, each request-response can have its own stream, depending on the endpoints' logic. This reduces HoL blocking down to the level of each individual request-response.

Internet Engineering Task Force (IETF), Oku et al. “Extensible Prioritization Scheme for HTTP,” RFC 9218 June 2022, describes “a scheme that allows an HTTP client to communicate its preferences for how the upstream server prioritizes responses to its requests.” “HTTP/2 [HTTP/2] and HTTP/3 [HTTP/3] support multiplexing of requests and responses in a single connection. An important feature of any implementation of a protocol that provides multiplexing is the ability to prioritize the sending of information. For example, to provide meaningful presentation of an HTML document at the earliest moment, it is important for an HTTP server to prioritize the HTTP responses, or the chunks of those HTTP responses, that it sends to a client.”

Prior to RFC 9218, IETF, Belshe et al. “Hypertext Transfer Protocol Version 2 (HTTP/2),” RFC 7540 May 2015, described that stream priority allowed a client to send a series of priority signals that communicate to the server a “priority tree”; the structure of this tree represents the client's preferred relative ordering and weighted distribution of the bandwidth among HTTP responses. However, it had several drawbacks, owing to its complexity, and it was deprecated in HTTP/2.

Stream prioritization influences scheduling such that more important information is sent earlier, and it works end-to-end, i.e., at the source and destination. RFC 9218 and RFC 7540 describe how server and client modulate their behavior to enhance performance (e.g., faster rendering of an HTTP resource). However, current stream prioritization techniques are limited in terms of the amount of performance enhancement achievable.

With L4S, network service providers have introduced dual queueing in their network (especially the access network, which may have limited capacity). While most queue-building traffic may pass through a regular/default queue, some traffic in need of low latency may use a low latency queue. This “priority lane” is typically expected to be used by ultra-low latency, non-queue-building traffic. However, there is a need to enable other applications (including queue-building applications) to benefit from this queue by enabling such applications to use it selectively.

To help overcome these problems, systems and methods are disclosed herein for receiving, from a client device over a network, a first urgency parameter in relation to a first portion of a network resource, wherein networking equipment associated with the network provides a first queue for preferential network traffic and a second queue for non-preferential network traffic. The disclosed systems and methods may identify, by a server, a second urgency parameter in relation to the first portion of the network resource, and based on at least one of the first urgency parameter or the second urgency parameter, determine whether to transmit the first portion to the client device over the network using the first queue or the second queue. The disclosed systems and methods may, based on the determining, cause the first portion of the network resource to be transmitted preferentially to the client device over the network using the first queue instead of the second queue.

Such aspects enable stream prioritization used in HTTP protocols to be used to determine whether an HTTP request-response stream is delivered with the explicitly requested assistance of the network, when providing a network resource to a client device. For example, L4S-enablement may be used in the underlying IP network delivery if a Boolean mapping function with priority parameters as input evaluates to TRUE(1). Dual queuing in network elements that support L4S may be used to reduce latency and packet loss, increasing throughput for delivery of a request response. For example, the disclosed techniques enable a network to assist in the delivery of transport byte streams to further enhance the delivery of priority information.

In some embodiments, the disclosed systems and methods may be further configured to receive, from the client device over the network, a third urgency parameter in relation to a second portion of the network resource, and identify, by the server, a fourth urgency parameter in relation to the second portion of the network resource. The disclosed systems and methods may be further configured to, based on at least one of the third urgency parameter or the fourth urgency parameter, determine whether to transmit the second portion to the client device over the network using the first queue or the second queue, and, based on the determining, causing the second portion of the network resource to be transmitted non-preferentially to the client device over the network using the second queue instead of the first queue.

In some embodiments, the first urgency parameter corresponds to the second urgency parameter. In some embodiments, the determining whether to transmit the first portion preferentially or non-preferentially to the client device over the network is based on the second urgency parameter and is not based on the first urgency parameter. In some embodiments, the determining whether to transmit the first portion preferentially or non-preferentially to the client device over the network is based on a combination of the first urgency parameter and the second urgency parameter.

In some embodiments, the disclosed systems and methods may be further configured to select, as a particular urgency parameter for the first portion of the network resource, the first urgency parameter, the second urgency parameter, or an urgency parameter obtained based on the first urgency parameter and the second urgency parameter; wherein the determining whether to transmit the first portion preferentially or non-preferentially to the client device over a network is based on comparing a value of the particular urgency parameter of the first portion to a threshold.

In some embodiments, the disclosed systems and methods may be further configured to receive, from the client device and in relation to the first portion of the network resource, a first incremental parameter, and identify, by the server and in relation to the first portion of the network resource, a second incremental parameter. In some embodiments, the determining whether to transmit the first portion preferentially or non-preferentially to the client device over the network is further based on at least one of the first incremental parameter or the second incremental parameter, wherein a first priority parameter comprises the first urgency parameter and the first incremental parameter, a second priority parameter comprises the second urgency parameter and the second incremental parameter, and each of the first and second incremental parameters is a Boolean value.

In some embodiments, the disclosed systems and methods may be further configured to select, as a particular urgency parameter for the first portion of the network resource, the first urgency parameter, the second urgency parameter, or an urgency parameter obtained based on the first urgency parameter and the second urgency parameter, and select, as a particular urgency parameter for the second portion of the network resource, the third urgency parameter, the fourth urgency parameter, or an urgency parameter obtained based on the third urgency parameter and the fourth urgency parameter. Based on determining that the particular urgency parameter for the first portion of the network resource matches the particular urgency parameter for the second portion of the network resource, the disclosed systems and methods may cause the determination of whether to transmit the first portion preferentially or non-preferentially to the client device over the network to be further based on at least one of a first incremental parameter or a second incremental parameter for the first portion.

In some embodiments, the first urgency parameter is an HTTP urgency parameter for retrieving an HTML document, an XML document, a JavaScript resource, or any combination thereof, corresponding to the network resource.

In some embodiments, causing the first portion of the network resource to be transmitted preferentially to the client device over the network using the first queue instead of the second queue is based at least in part on a file size or expected tonnage associated with the first portion of the network resource.

In some embodiments, the network resource comprises a plurality of portions including a plurality of short-form videos, and the disclosed systems and methods may be further configured to select, as a particular urgency parameter for the first portion of the network resource, the first urgency parameter, the second urgency parameter, or an urgency parameter obtained based on the first urgency parameter and the second urgency parameter. While a particular short-form video of the plurality of short-form videos corresponding to the first portion is being played at the client device, the disclosed systems and methods may be further configured to set the particular urgency parameter for the particular short-form video higher than a plurality of urgency parameters for the other of the plurality of short-form videos; prebuffering the plurality of short-form videos based at least in part on the plurality of urgency parameters; and, based on current network conditions, adjusting one or more of the plurality of urgency parameters.

In some embodiments, the disclosed systems and methods may be further configured to select, as a particular urgency parameter for the first portion of the network resource, the first urgency parameter, the second urgency parameter, or an urgency parameter obtained based on the first urgency parameter and the second urgency parameter, and set the particular urgency parameter for the first portion of the network resource based at least in part on a location of the client device in relation to a plurality of locations proximate to the location of the client device.

In some embodiments, the disclosed systems and methods may be further configured to cause the first portion of the network resource to be transmitted preferentially to the client device over the network using the first queue instead of the second queue based on a type of the first portion of the network resource.

In some embodiments, the first portion comprises an advertisement, and a value of at least one of the first urgency parameter or the second urgency parameter for the first portion for the advertisement is increased based on an indication received from a provider of the advertisement.

In some embodiments, the first portion comprises an application available for download, and a value of at least one of the first urgency parameter or the second urgency parameter for the first portion for the application available for download is increased based on an indication received from a provider of the application.

### BRIEF DESCRIPTION OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and should not be considered limiting of the breadth, scope, or applicability of these concepts. It should be noted that for clarity and ease of illustration, these drawings are not necessarily made to scale.

FIG. 1 shows an illustrative architecture for a system for processing network traffic, in accordance with some embodiments of this disclosure.

FIGS. 2A-2B show illustrative block diagrams for providing a dual queue service configuration, in accordance with some embodiments of this disclosure.

FIG. 3 shows an illustrative diagram of network traffic in a system, in accordance with some embodiments of this disclosure.

FIG. 4 shows illustrative marking of explicit congestion notification (ECN) bits, in accordance with some embodiments of this disclosure.

FIG. 5 shows an illustrative network resource, in accordance with some embodiments of this disclosure.

FIG. 6 shows a flowchart of an illustrative process treating portions of a network resource preferentially, in accordance with some embodiments of this disclosure

FIG. 7 shows an illustrative block diagram showing functions performed by various layers in the networking stack of a sender, in accordance with some embodiments of this disclosure.

FIG. 8 shows an illustrative user interface, in accordance with some embodiments of this disclosure.

FIGS. 9-10 show illustrative devices and systems for selectively treating portions of network traffic preferentially, in accordance with some embodiments of this disclosure.

FIG. 11 is a flowchart of a detailed illustrative process for preferential treatment of portions of network traffic, in accordance with some embodiments of this disclosure.

### DETAILED DESCRIPTION

Throughout the specification the phrases “in response to” and “based on” shall be understood to have a broad meaning unless context requires otherwise. For example, “in response to” can refer to a step that is in direct or indirect response to a prior step, and “based on” can refer to a step that is based at least in part on a prior step.

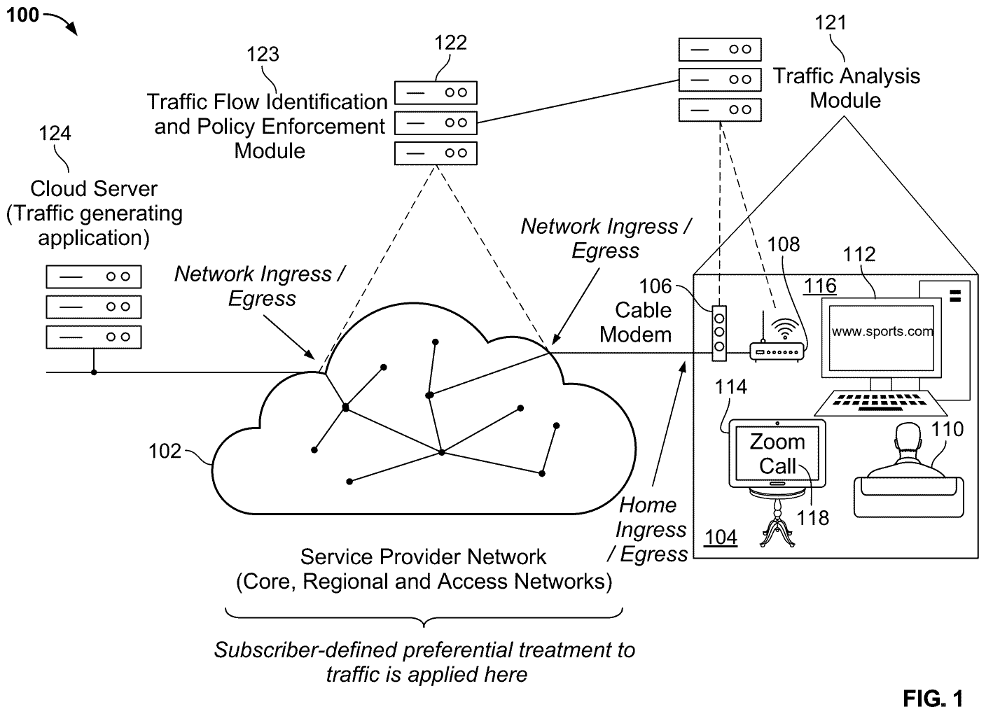

FIG. 1 shows an illustrative architecture for processing network traffic, in accordance with some embodiments of this disclosure. System 100 may comprise service provider network 102, physical location 104 (e.g., a home of user 110, a place of business, a school, or any other suitable location, or any combination thereof), networking equipment 106 and 108 (e.g., a modem, router, switch, gateway, wireless access point, mesh access point, extender, hub, and/or any other suitable networking equipment), devices 112 and 114, and/or any other suitable components. In some embodiments, modem 106, router 107 and/or networking equipment 122 may comprise a traffic analysis module 121 and/or a traffic flow identification and policy enforcement module (TIPE) module 123. In some embodiments, cloud server 124 comprises a traffic generating application 125. System 100 may comprise any suitable combination of hardware and/or software to provide the functionalities described herein.

Service provider network 102 may include, for example, any suitable software and/or hardware (e.g., networking equipment, servers, and/or databases) and/or any suitable infrastructure (e.g., physical cable transmission lines, fiber-optic transmission channels or mediums or channels, satellites) to provide core, regional, access networks and/or backhaul (and/or any other suitable portion of the network) of one or more Internet service providers (ISPs), to facilitate a telecommunications network. In some embodiments, the ISP may be provided by a business or other organization that provides access to the Internet for a fee. For example, service provider network 102 may correspond to or comprise a wide area network (WAN), to facilitate Internet connectivity (or connectivity over any other suitable public or private network) between networked devices worldwide or over any other suitable geographic region or location(s), to enable such devices to exchange information and resources. In some embodiments, a WAN or service provider network 102 may be used to connect LANs (and/or other types of communication) to enable electronic communications between remotely located devices. In the example of FIG. 1, the local area network (LAN), e.g., a small scale network for data exchange between a group of computers or other devices at a single location, provided at location 104 by way of networking equipment 106 and/or 108, may not be considered as part of the WAN provided by service provider network 102. Service provider network 102 may provide broadband, high bandwidth Internet access.

In some embodiments, networking equipment 122 and cloud server 124 may be located remote from location 104. The devices, servers, and networking equipment of system 100 may communicate over a wired connection and wireless connection. For example, devices 112, 114 and networking equipment 106 and 108 may be equipped with antennas for transmitting and receiving electromagnetic signals at frequencies within the electromagnetic spectrum, e.g., radio frequencies, to communicate with each other over a network in a localized area. The network within location 104 may correspond to, e.g., a wireless fidelity (Wi-Fi) network, such as, for example, 802.11n, 802.11ac, 802.11ax, Wi-Gig/802.11ad, 802.11 (Wi-Fi 7) at a fronthaul of a telecommunications network, to provide wireless networking technology allowing electronic devices to connect to one another and/or the Internet from a shared network access point.

The devices of system 100 may communicate over a wired LAN and/or may communicate wirelessly over a wireless LAN (WLAN) and to transmit data to and receive data from the Internet, and may be present within an effective coverage area of the localized network. The Internet is a global system of interconnected computer networks and devices employing common communication protocols, e.g., TCP, user datagram protocol (UDP) and the Internet protocol (IP) in the TCP/IP or UDP/IP suite.

Router 108 may be configured to forward or route data packets from the Internet connection, received by way of modem 106, to devices within the localized network of system 100 and receive data packets from such devices. In some embodiments, router 108 may include a built-in modem to provide access to the Internet for the household (e.g., received by way of cable or fiber connections included in backhaul portions of a telecommunications network), built-in switches or hubs to deliver data packets to the appropriate devices within the Wi-Fi network, built-in access points to enable devices to wirelessly connect to the Wi-Fi network, and/or system 100 may include one or more stand-alone modems, switches, routers and access points. In some embodiments, modem 106 and/or router 108 may be leased from and/or installed at location 104 (e.g., the customer's premises) by the ISP as part of a managed Wi-Fi install, to give service provider network 102 visibility into LAN and WAN network traffic associated with data transmitted to or receive from modem 106 of location 104.

In some embodiments, one or more applications and/or media assets may be provided to user 110 by way of wired or wireless signals transmitted through the LAN at location 104. For example, user 110 may be accessing a website 116 (e.g., “www.sports.com”), or other suitable network resource, via computer 112, which may be connected to the Internet via the LAN within location 104 to provide such network resource. As another example, tablet 114 may additionally or alternatively be connected to the Internet via the LAN to provide a video conferencing application (e.g., Zoom) 118 to user 110.

In some embodiments, devices 112 and 114 may be, for example a headset; a mobile device such as, for example, a smartphone or tablet; a laptop computer; a personal computer; a desktop computer; a smart television; a smart watch or wearable device; smart glasses; extended reality (XR) head-mounted display (HMD); a stereoscopic display; a wearable camera; XR glasses; XR goggles; a near-eye display device; a robot; an autonomous cleaning device; or any other suitable user equipment or device capable of connecting to the Internet or other suitable network; or any combination thereof. In some embodiments, traffic analysis module 121 and TIPE module 123 may be implemented in conjunction to achieve one of more of the functionalities described herein.

XR may be understood as virtual reality (VR), augmented reality (AR) or mixed reality (MR) technologies, or any suitable combination thereof. VR systems may project images to generate a three-dimensional environment to fully immerse (e.g., giving the user a sense of being in an environment) or partially immerse (e.g., giving the user the sense of looking at an environment) users in a three-dimensional, computer-generated environment. Such environment may include objects or items that the user can interact with. AR systems may provide a modified version of reality, such as enhanced or supplemental computer-generated images or information overlaid over real-world objects. MR systems may map interactive virtual objects to the real world, e.g., where virtual objects interact with the real world or the real world is otherwise connected to virtual objects.

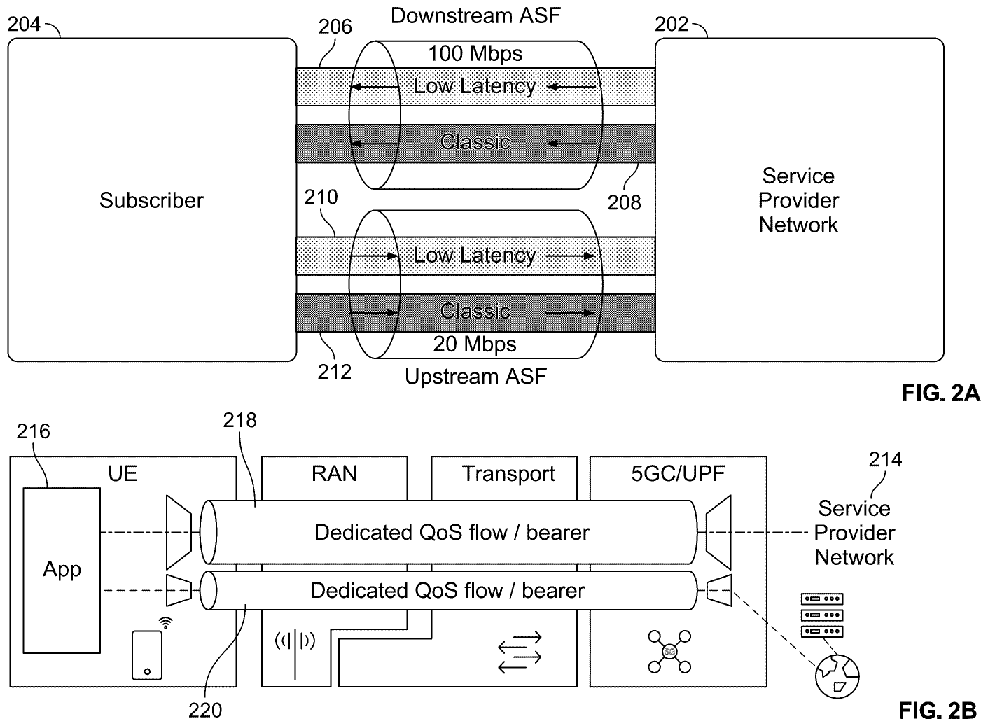

FIGS. 2A-2B show illustrative block diagrams for providing a dual queue service configuration, in accordance with some embodiments of this disclosure. System 100 may provide (e.g., in the WAN) a queue for low latency (e.g., L4S) network traffic and a queue for classic traffic, based at least in part using networking equipment 122 of FIG. 1. For example, the low latency queue of system 100 may be associated with low latency service flow 206 and low latency service flow 210, and the classic queue of system 100 may be associated with classic queue of service flow 208 and 212, as discussed in more detail in as White et al., “Low Latency DOCSIS: Technology Overview,” Cable Labs, 2019 Fall Technical Forum SCTE-ISBE (hereinafter “White et al.), the contents of which are hereby incorporated by reference herein in their entirety. A downstream aggregate service flow (ASF) over service flow 206, 210 between subscriber 204 and service provider network 202 may include low latency service flow 206 and classic service flow 210, and an upstream ASF between subscriber 204 and service provider network 202 may include low latency service flow 210 and classic service flow 212. In some embodiments, networking equipment (e.g., modem 106 and/or router 108 and/or other networking equipment) may provide one or more buffers or other suitable memory at which the low latency queue and the classic queue may be stored. In some embodiments, system 100 may employ per-flow queues and/or per-flow AQMs, in addition to or in the alternative to dual-queuing.

In some embodiments, service provider network 202 may correspond to service provider network 102 of FIG. 1, networking equipment modem 106 and/or router 108, and subscriber 204 may correspond to networking equipment 106, 108 of user 110 at location 104 of FIG. 1. FIG. 2B may correspond to an architecture for a cellular network, and service provider network 214 which may correspond to service provider network 102 of FIG. 1, and client device or user equipment 216 may correspond to service provider network 102 of FIG. 1, networking equipment 122 and/or cloud server 124.

L4S provides an end-to-end solution to provide certain traffic flows, such as, for example, gaming or voice, with reduced latency. With L4S, the data source and/or data recipient may execute congestion control algorithms to efficiently utilize available capacity while minimizing latency and packet loss, where the data source may use congestion feedback received from the recipient to optimize data transmission. With L4S, the header of an IP packet may indicate, via an explicit congestion notification (ECN), whether the IP packet supports L4S and whether congestion is being experienced, e.g., marking specific packets as having queuing delay that exceeds a threshold. L4S may be implemented at the transport layer by the service provider network and/or application service providers at client and server. In some embodiments, L4S may be enabled by operating system (OS) providers, such as, for example, Google and Apple.

As stated in RFC 9330, “The Dual-Queue Coupled AQM . . . acts like a ‘semi-permeable’ membrane that partitions latency but not bandwidth. As such, the two queues are for transitioning from Classic to L4S behavior, not bandwidth prioritization.” RFC 9330 further states that “[t]wo separate queues are used to isolate L4S queuing delay from the larger queue that Classic traffic needs to maintain full utilization” and “The two queues act as if they are a single pool of bandwidth in which flows of either type get roughly equal throughput without the scheduler needing to identify any flows.”

RFC 9330 further states that “the scheduler can serve the L4S queue with priority (denoted by the ‘l’ on the higher priority input), because the L4S traffic isn't offering up enough traffic to use all the priority that it is given. Therefore, for latency isolation on short timescales (sub-round-trip), the prioritization of the L4S queue protects its low latency by allowing bursts to dissipate quickly; but for bandwidth pooling on longer timescales (round-trip and longer), the Classic queue creates an equal and opposite pressure against the L4S traffic to ensure that neither has priority when it comes to bandwidth—the tension between prioritizing L4S and coupling the marking from the Classic AQM results in approximate per-flow fairness.”

As further stated in White et al., AQM can ensure that the Classic queue is not starved: “To enable the Low Latency Queue to rapidly dequeue an arrived burst of traffic, the Inter-Service-Flow scheduler gives a higher weight to the Low Latency Queue than it does to the Classic Queue. The coupling to the Low Latency AQM counterbalances the weighted scheduler by making low-latency applications leave space for Classic traffic. This ensures that the weighted scheduler does not give priority over bandwidth, as a traditional weighted scheduler would.” Further, as stated in Internet Engineering Task Force (IETF), “Dual-Queue Coupled Active Queue Management (AQM) for Low Latency, Low Loss, and Scalable Throughput (L4S),” RFC 9332 January 2023, (referred to herein as RFC 9332), the contents of which are hereby incorporated by reference herein in their entirety: “The scheduling weight of the Classic queue should be small (e.g., 1/16) . . . if L4S traffic is over-aggressive or unresponsive, the scheduler weight for Classic traffic will at least be large enough to ensure it does not starve in the short term” and “The scheduler draining the two queues MUST give L4S packets priority over Classic, although priority MUST be bounded in order not to starve Classic traffic” and “The L4S queue has latency priority within sub-round-trip timescales, but over longer periods the coupling from the Classic to the L4S AQM . . . ensures that it does not have bandwidth priority over the Classic queue.”

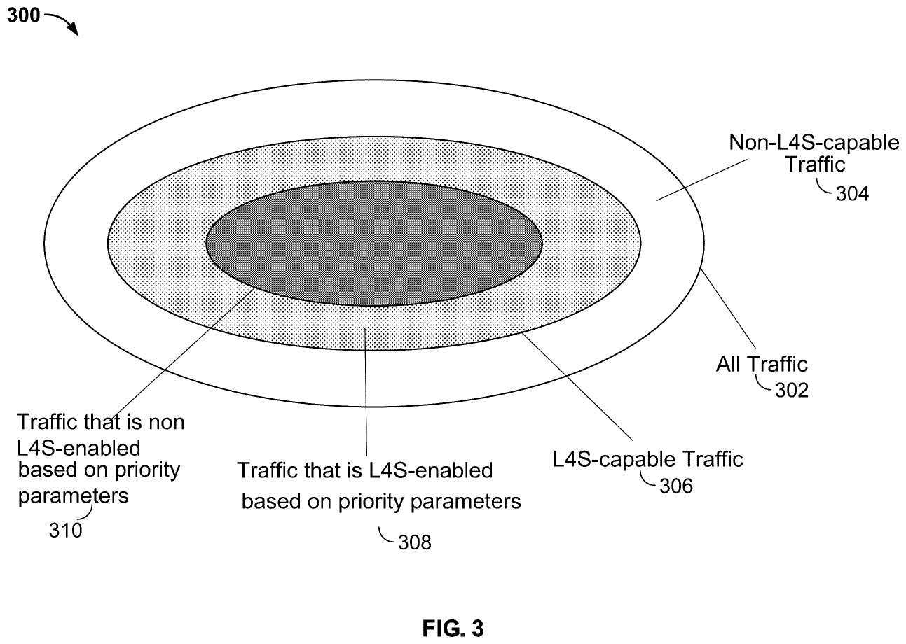

FIG. 3 shows an illustrative Venn diagram 300 of network traffic in system 100, in accordance with some embodiments of this disclosure. In some embodiments, system 100 may utilize the L4S standard, and/or any other suitable standard or techniques to treat certain portions of network traffic presently. As shown in FIG. 3, system 100 may categorize network traffic 302 as non-L4S-capable traffic 304 or L4S-capable traffic 306. L4S-capable traffic 306 may comprise traffic 308 that is L4S-enabled based on priority parameters, as discussed in more detail below, and traffic 310 that is not L4S-enabled based on priority parameters. In some embodiments, portions of a network resource that are not L4S-capable may be assigned priority parameters indicative of non-urgent and processed using the second queue for non-preferential network traffic.

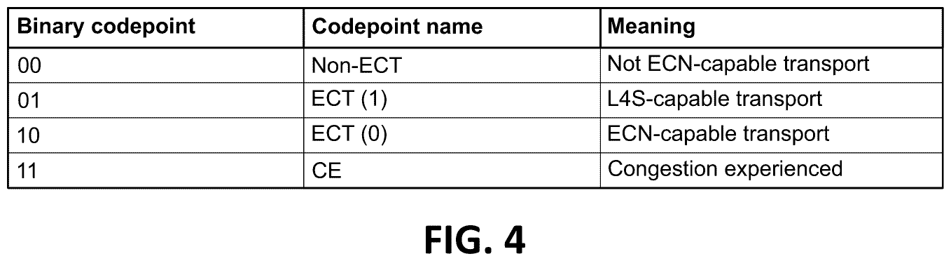

FIG. 4 shows illustrative marking of explicit congestion notification (ECN) bits, in accordance with some embodiments of this disclosure. In some embodiments, to determine whether a packet should be assigned to a low latency service flow (e.g., 206, 210, 218 of FIGS. 2A-2B), ISPs and application service providers of low latency traffic (e.g., cloud gaming) of system 100 may mark portions of their traffic with a codepoint, e.g., a differentiated services (DiffServ) codepoint or any other suitable codepoint. This codepoint indicates the ISP's and/or application service provider's ability to perform scalable congestion control, e.g., to respond to a congestion notification in a graceful manner that does not aggressively reduce throughput. For example, the ISP or application service provider may use the DiffServ field information (in the network packet IP header) to shift a packet to the low latency service flow in a “weakest link” of the network, such as, for example, the access network. In some embodiments, the ISP may signal congestion using an ECN field when appropriate, to produce a graceful degradation in throughput from the application service provider's server. In some embodiments, an ISP and/or application service provider may allow a customer to indicate that network traffic to a particular device and/or for a particular application, e.g., based on a particular service type associated with the application, should be provided with latency priority, e.g., assigned to the low latency service flow.

In some embodiments, ECN may be contained within the DiffServ codepoint to indicate whether or not congestion is experienced by marking the two least-significant bits in the DiffServ in the IP header identifying a data packet. For example, the most significant six bits in the DiffServ field may contain the differentiated services code point (DSCP) bits, and the state of the two ECN bits indicates whether or not the packet is an ECN-capable packet and whether or not congestion has been experienced. A sender of network traffic may indicate a packet as ECN-capable or non-ECN-capable based on whether the sender is ECN-capable. If an ECN-capable packet experiences congestion at the egress queue of a switch, router, and/or other network component, such switch, router, and/or other network component may mark the packet as experiencing congestion. When the packet reaches the ECN-capable receiver (destination endpoint), the receiver echoes the congestion indicator to the sender (source endpoint) by sending a packet marked to indicate congestion, and after receiving the congestion indicator from the receiver, the source endpoint reduces the transmission rate to relieve the congestion,” as described in “Understanding CoS Explicit Congestion Notification,” Juniper Product and Release Support, Nov. 29, 2023, the contents of which are hereby incorporated by reference herein in their entirety.

As shown in FIG. 4, in some embodiments, two ECN bits in the DiffServ field provide four codes that determine if a packet is marked as an ECN-capable transport (ECT) packet, meaning that both endpoints of the transport protocol are ECN-capable, and if there is congestion experienced (CE). Historically, codes 01 and 10 had the same meaning, namely that the sending and receiving endpoints of the transport protocol are ECN-capable, and there was no difference between these codes. Recent work, however, earmarks ECT(1) as the bit pattern for L4S-capable traffic. System 100 may modify such interpretation of the ECN bits by assigning distinct meanings to ECT(0) and ECT(1) in order to designate at least two different traffic classes. In some embodiments, ECT(1), e.g., bit pattern 01, may be used to indicate L4S-capable traffic, and ECT(0), e.g., bit pattern 10, may be used to indicate that the sender is capable of receiving explicit congestion notification (though the sender may not be compliant with L4S). In some embodiments, L4S-capable traffic marked by an application server is assigned to ECT(1) and L4S-capable traffic marked by an ISP is assigned to ECT(0). For example, ECT(0) is used as an internal reference for network traffic that is designated as preferential by the ISP rather than the application provider. In some embodiments, ISPs can independently choose which bit combination represents one of the two classes described above, or multiple ISPs can agree on the definition and/or choice of ECT(0) and ECT(1). In some embodiments, system 100 may add one or more extra bits to be added, specifically to indicate whether such a data packet having such bits was marked by an ISP operator or application service provider providing L4S enablement.

In some embodiments, the same bits that are used for designating whether the client-server are ECN-capable may also be used for marking whether congestion is actually experienced in the network (bits 11: CE). Thus, if a packet has the ECN bits marked as CE, then, in order to classify it as either marked by the application service provider or by the ISP (to meter the traffic accurately and apply policy), the ISP may perform a lookup of that flow identifier (ID) from a prior packet belonging to the same network traffic flow to check its traffic class, to determine whether the sender packet was marked with 10 or 01.

As described in more detail below, system 100 may be configured to enable application service providers and/or the ISP to intelligently determine whether a portion of data being transmitted or to be transmitted to a device (e.g., device 112 or 114 of FIG. 1 at particular location 104 of FIG. 1) over a network (e.g., service provider network 102) should be provided using the a first queue for preferential (e.g., L4S-capable) network traffic (e.g., via service flow 206, 210, and/or 218 of FIGS. 2A-2B) and a second queue for non-preferential (e.g., non-L4S) network traffic (e.g., via service flow 208, 212, and/or 220 of FIGS. 2A-2B). For example, system 100 may selectively employ the first queue based on a latency requirement for a portion of the data related to the user experience to be provided to the device on the LAN during a network session, and/or based on other characteristics of such portion of data. In some embodiments, network session data provided to the device on the LAN during a network session may comprise a plurality of portions of data, where certain portions may be treated preferentially (e.g., provided to the device using the first queue) during the network session, and other portions of the data may be treated non-preferentially (e.g., provided to the device using the second queue) during the network session, based on the respective characteristics of such portions. In some embodiments, a network session may be understood as a lasting connection comprising exchange of data packets between a client device and a server, e.g., implemented as a layer in a network protocol.

In some embodiments, such preferential treatment may be selectively turned on and off based on determining whether to employ L4S (or not) for the portions of the network session data. In some embodiments, system 100 may use L4S in conjunction with one or more other techniques, e.g., DiffServ, to forward packets via low latency service flow at the expense of packets over the classic service flow. In some embodiments, if a particular portion of a traffic flow is not L4S-capable, system 100 may cause an ISP and/or application service provider to be informed of the request, which may cause the ISP and/or application service provider to configure the network traffic to be L4S-capable (e.g., via an API call).

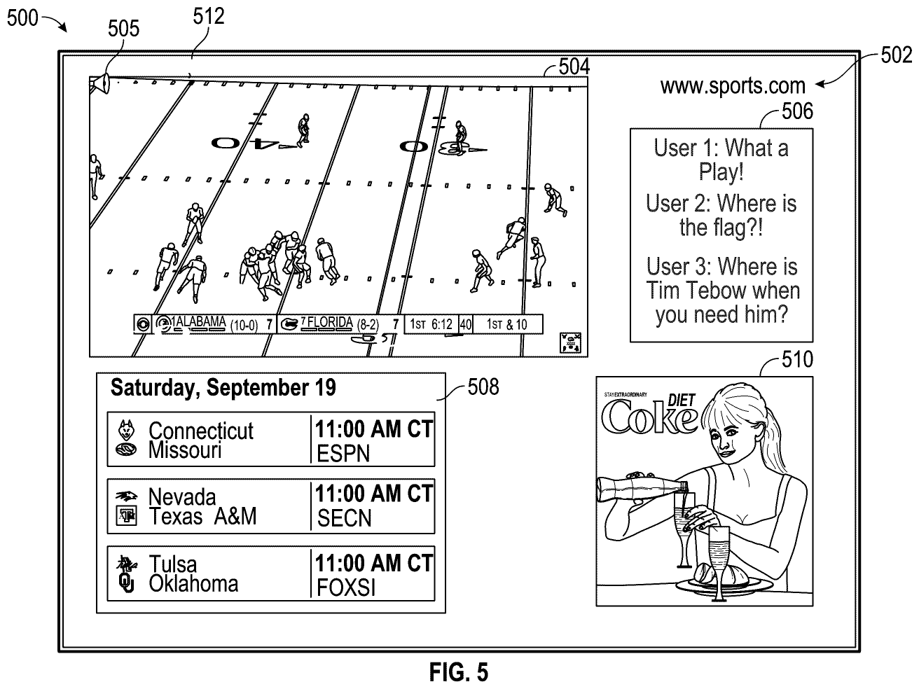

FIG. 5 shows an illustrative network resource 500, in accordance with some embodiments of this disclosure. Network resource 500 may be, for example, a web page or web site accessed via a web browser or other application, or any other suitable content, file, or other data accessed via any suitable technique from any suitable source. Network resource 500 may be provided to a user (e.g., user 110 of FIG. 1) that is using a device 512 (e.g., corresponding to computer 112 of FIG. 1), based on receiving a request from computer 112 to access such network resource, e.g., associated with the URL 502 www.sports.com. Network resource 500 may comprise a plurality of portions, e.g., a plurality of resources, such as, for example, video portion 504 of a college football game, audio portion 505 of a college football game, chat portion 506, scoreboard portion 508, and advertisement portion 510.

In some embodiments, network resource 500 is provided, e.g., by a content server and/or a web server (e.g., cloud server 124 of FIG. 1) and/or edge server(s) of a CDN, to device 512 using the HTTP protocol or any other suitable protocol. In some embodiments, a request received by the web server from device 512 may include HTTP priority parameters for a transport stream. As stated in RFC 9218, “The priority information is a sequence of key-value pairs, providing room for future extensions. Each key-value pair represents a priority parameter” where such priority parameters are contained in the “Priority HTTP header field, which is an end-to-end priority signal that is independent of protocol version. Clients can send this header field to signal their view of how responses should be prioritized.” RFC 9218 “defines the urgency (u) and incremental (i) priority parameters.”

As further stated in RFC 9218, “The urgency (u) parameter value is Integer . . . between 0 and 7 inclusive, in descending order of priority. The default is 3. Endpoints use this parameter to communicate their view of the precedence of HTTP responses. The chosen value of urgency can be based on the expectation that servers might use this information to transmit HTTP responses in the order of their urgency. The smaller the value, the higher the precedence.” RFC 9218 further states that “[t]he following example shows a request for a CSS file with the urgency set to 0:

```
:method = GET
  :scheme = https
  :authority = example.net
  :path = /style.css
  priority = u=0.”
```

RFC 9218 further states that “[a] client that fetches a document that likely consists of multiple HTTP resources (e.g., HTML) SHOULD assign the default urgency level to the main resource. This convention allows servers to refine the urgency using knowledge specific to the website . . . . The lowest urgency level (7) is reserved for background tasks such as delivery of software updates. This urgency level SHOULD NOT be used for fetching responses that have any impact on user interaction.”

In some embodiments, a request received by a web server (e.g., cloud server 124 of FIG. 1) from device 512 may include one or more incremental parameters. RFC 9218 states that “[t]he incremental (i) parameter value is Boolean . . . . It indicates if an HTTP response can be processed incrementally, i.e., provide some meaningful output as chunks of the response arrive.

The default value of the incremental parameter is false (0). If a client makes concurrent requests with the incremental parameter set to false, there is no benefit in serving responses with the same urgency concurrently because the client is not going to process those responses incrementally. Serving non-incremental responses with the same urgency one by one, in the order in which those requests were generated, is considered to be the best strategy. If a client makes concurrent requests with the incremental parameter set to true, serving requests with the same urgency concurrently might be beneficial. Doing this distributes the connection bandwidth, meaning that responses take longer to complete. Incremental delivery is most useful where multiple partial responses might provide some value to clients ahead of a complete response being available.” The following example shows a request for a JPEG file with the urgency parameter set to 5 and the incremental parameter set to true.

```
  :method = GET
  :scheme = https
  :authority = example.net :path = /image.jpg
priority = u=5, i”
```

For example, Google Chromium maps urgency numbers to (0, 1, 2, 3, 4), while Safari uses (0, 1, 3, 5, 7), and Firefox skips 0 (1, 2, 3, 4), e.g., lower number values are more important and indicate higher urgency, regardless of which exact number is used. A developer can set the urgency value in JavaScript API, e.g., using a setUrgency( ) method which takes an integer value as its argument, and which represents the urgency level. The urgency level can be any value from 0 to 10, with 0 being the lowest number (and highest urgency) and 10 being the highest number (and lowest urgency). Another way to set the urgency value is to use the priority property. This property takes a string value as its argument, which represents the urgency level. The urgency level can be one of the following values: “low,” “medium,” and “high.” To set the incremental flag in JavaScript for an HTTP request, the setRequestHeader( ) method can be used with the syntax JavaScript xhr.setRequestHeader(‘Incremental’, ‘true’).

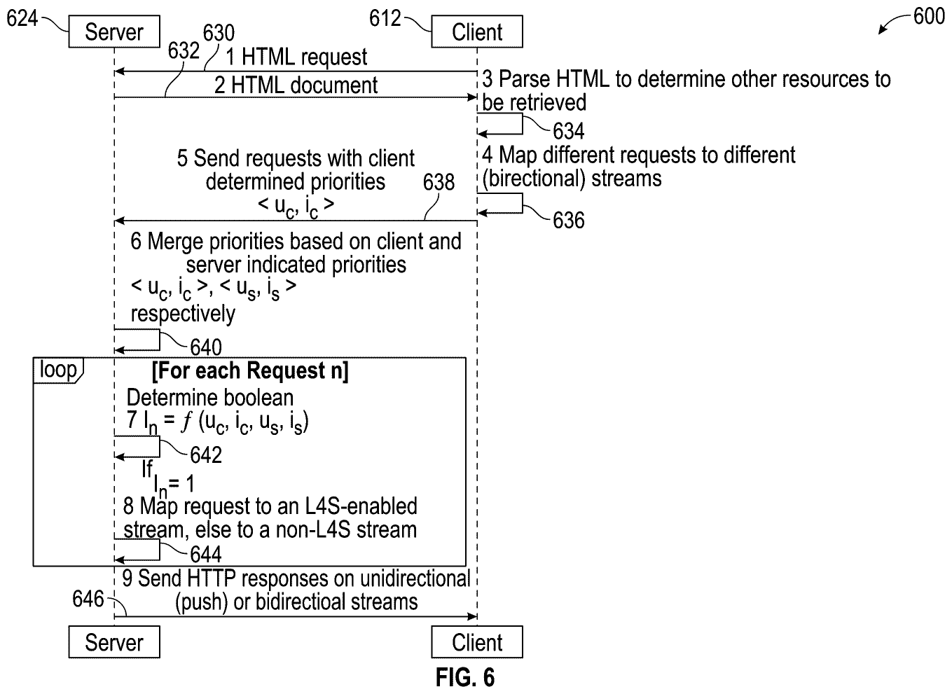

FIG. 6 shows a flowchart of an illustrative process 600 for treating portions of a network resource preferentially, in accordance with some embodiments of this disclosure. In various embodiments, the individual steps 630-646 of process 600 may be implemented by one or more components of the devices, methods, and systems of FIGS. 1-5 and 7-11 and may be performed in combination with any of the other processes and aspects described herein. Although the present disclosure may describe certain steps 630-646 of process 600 (and of other processes described herein) as being implemented by certain components of the devices, methods, and systems of FIGS. 1-5 and 7-11, this is for purposes of illustration only, and it should be understood that other components of the devices, methods, and systems of FIGS. 1-5 and 7-11 may implement those steps instead. While this example primarily focuses on using the HTTP protocol, it should be appreciated that the techniques described herein may be used in relation to any suitable protocol for delivering any suitable network resource to clients.

At 630, server 624 (e.g., server 124 of FIG. 1) may receive an HTML request from client device 612 (e.g., device 112 of FIG. 1, 512 of FIG. 5). At 632, server 624 transmits a network resource (e.g., an HTML document 632) to client device 612. At 634, client device 612 may initially parse a resource such as an HTML document (e.g., network resource 500 of FIG. 5) received from server 624 at 632, to understand what additional resources are needed for a complete render. For example, once client device 612 determines the resources needed for the complete render (e.g., based on information received from server 624), client device 612 determines a priority for each resource (or portion thereof) based on its determination of how it must render the complete top-level resource. In some embodiments, at 636, client device 612 may map each of these requests to a stream (e.g., if using bidirectional streams). At 638, client device 612 may send each of these requests to server 624, such as, for example, with the priorities (e.g., urgency parameter and/or incremental parameter) embedded in the HTTP request header of data transmitted to server 624. In some embodiments, if no priorities are set, then the request priority defaults to 3.

In some embodiments, HTML document 632 may additionally or alternatively comprise an XML (extensible markup language) document, and/or any other suitable data. The XML document may comprise URLs for requesting data needed for the application. One example is adaptive bit rate (ABR) manifest files, e.g., XML files comprising URLs for retrieving the video and audio streams at different bitrates to be played in an ABR player at client device 612. In some embodiments, HTML document 632 may additionally or alternatively comprise an XML Outline Processor Markup Language (OPML), e.g., an XML file comprising a list of subscriptions to podcasts. This file can be used by podcast players to keep track of the latest episodes from the podcasts that the user is subscribed to. OPML XML files can also comprise URLs to the podcast episodes, which can be used to play the episodes. In some embodiments, HTML document 632 may additionally or alternatively comprise a Really Simple Syndication (RSS) XML which is an XML file comprising a list of recent articles from a website. This file can be used by, for example, newsreaders to keep track of the latest articles from a website. RSS XML files may comprise URLs to the full articles, which can be used to read the articles in full. In some embodiments, HTML document 632 may additionally or alternatively comprise an Atom XML, an XML file similar to an RSS XML file but potentially more flexible and capable of being used to represent a wider variety of data. Atom XML files may comprise URLs to the full articles, which can be used to read the articles in full. In this case, the specific application may be chosen based on the application's determined priority and incremental settings.

At 638, server 624 receives, from client device 612, the requests (e.g., portions of network resource 600) mapped to the priorities/urgencies parameters and/or incremental parameters. For example, the requests may respectively correspond to different portions of network resource 500, e.g., video portion 504 of a college football game, audio portion 505 of a college football game, chat portion 506, scoreboard portion 508, advertisement portion 510, any suitable portion(s) thereof, or any other suitable network resource(s). Server 624 may retrieve or determine its own interpretation of the priorities with which each of the requests should be served, or it may accept the priorities signaled by the client. For example, RFC 9218 states that “[n]o guidance is provided for merging priorities; this is left as an implementation decision. The absence of a priority parameter in an HTTP response indicates the server's disinterest in changing the client-provided value. This is different from the request header field, in which omission of a priority parameter implies the use of its default value.”

In some embodiments, server 624 may be optimized for the prioritization for the delivery of the data along with enabling or disabling the low latency. In some embodiments, server 624 may be a smart server specifically for playing OTT video. Server 624 may already include optimization for the prioritization for the delivery of the data along with enabling or disabling the low latency. In some embodiments, server 624 may be optimized for prebuffering multiple short-form videos. In these examples, server 624 may understand and/or access information related to the data to be delivered that the client may not have access to (e.g., bandwidth information on the network overall), to help inform urgency parameters to be set to different portions of network resource 500.

Urgency values set by client device 612 and/or server 624 for portions of network resource 500 may be based on any suitable criteria. For example, client device 612 and/or server 624 may take into account a main purpose of the network resource (e.g., to watch a live college football game or highlights of a college football game), and thus video portion 504 may be given the lowest number for the urgency parameter (indicating the urgency is highest) of each portion of network resource 500 (causing video portion 504 content to be processed using a first queue for low latency traffic), followed by audio portion 505 of the college football game or highlights.

In some embodiments, client device 612 and/or server 624 may take into account preferences of the user (e.g., user 110) accessing network resource 500, preferences of users generally, popularity of certain portions (e.g., Taylor Swift in advertisement 510), preferences of content providers (e.g., an advertiser may pay extra to a website to have their advertisements prioritized, such as advertiser 510), and/or any other suitable criteria, in determining urgency values to be assigned to different portions of network resource 500. In some embodiments, certain types of resources or portions thereof may generally be assigned lower urgency values (and thus treated more urgently by the network). For example, since a progressive JPEG is typically better than a normal JPEG in terms of a user experience, and potentially less-bandwidth intensive, a progressive JPEG could be loaded with lesser urgency than a normal JPEG (particularly if the JPEG is a “hero image” on the webpage).

As another example, in some embodiments, an application provider may require that chat portion 506 should be treated preferentially over the scoreboard portion 508, since chat portion 506 is interactive, e.g., chat portion 506 may be assigned a lower number for an urgency value, indicating that chat portion should be treated more urgently than scoreboard portion 508.

At 640, server 624 may merge priorities based on client and server indicated priorities <u_{c}, i_{c}>, <uₛ, iₛ>, respectively. Server 624 may, at 642, determine the client and server priorities for each request (stored, received or merged), for each request server 624 may calculate a Boolean value In based on these priorities:

f(u_{c},i_{c},uₛ,iₛ).

where u_{c} is the urgency parameter determined by client device 612 for a particular portion of network resource 500, i_{c} is the incremental parameter determined by client device 612 for the particular portion of network resource 500, uₛ is the urgency parameter determined by server 624 for a particular portion of network resource 500, and iₛ is the incremental parameter determined by server 624 for the particular portion of network resource 500. As shown at 644, if the Boolean value is TRUE, then the request response is mapped to an L4S-enabled stream; on the other hand, if the Boolean value is FALSE, then the request response is mapped to a non-L4S stream.

In some embodiments, HTTP server 624 reads only the urgency value of the client request in the header and makes a decision on whether to enable L4S for the response stream (unidirectional, or bidirectional if request and response are on the same stream). In some embodiments, server 624 ignores the value communicated by the client and uses its server-provided urgency value uₛ to determine whether to send the response on an L4S-enabled stream. In some embodiments, server 624 uses some pre-determined logic to blend u_{c} and uₛ into a new value for making a decision as to whether the response shall be L4S-enabled. For example, server 624 may use certain u_{c} values as the urgency parameters for certain portions of network resource 500, and may use certain uₛ values as the urgency parameters for certain portions of network resource 500, and/or server 624 may determine an average urgency parameter based on Uc values and uₛ values, or employ any other suitable techniques in blending the u_{c} values and uₛ values.

$$If {u}_{c / s} \leq V , {l}_{n} = 1$$

$$If {u}_{c / s} > V , {l}_{n} = 0$$

where u_{c/s} denotes the urgency parameter after consideration of both received (from client device 612) and pre-stored, or otherwise determined, at server 624 urgency values. The above conditions illustrate specific logic that may be used to determine whether the Boolean value lₙ is TRUE (1) or FALSE (0). If the urgency parameter u_{c/s} is less than or equal to a threshold V, then lₙ is TRUE (since a lower value corresponds to a higher urgency). On the other hand, if urgency parameter u_{c/s} is greater than a threshold V′, then lₙ is FALSE. In some embodiments, threshold parameter V may be implementation-dependent, or may be default value, and/or may be set to 0, 1 or 2.

In some embodiments, client device 612 transmits a request for a network resource or portions thereof with information indicating u_{c} and i_{c}, and server 624 may determine, based on u_{c}, i_{c}, uₛ, and/or iₛ, a subset of packets to satisfy the request, which may be delivered with L4S enabled and another subset of the packets may be delivered with L4S disabled. In this case, the value of the Boolean function may be dependent on other factors in addition to u_{c}, i_{c}, uₛ, and/or iₛ, e.g., chunk size within a segment, such that the value of In may dynamically change between TRUE and FALSE. Based on this dynamically changing mapping of In, each packet that is being delivered to the client device may or may not be L4S-enabled based on the decision by server 624.

In some embodiments, when the urgency parameter for multiple requests (e.g., respective requests for scoreboard portion 508 and advertisement 510) is the same, then server 624 may also consider the incremental parameter in determining whether a request response shall be delivered on an L4S stream (or other preferentially treated stream). Consider, as an example, an HTTP server 624 that is serving requests in decreasing order of urgency (increasing order of the u parameter), e.g., currently it is serving requests that have an urgency value of u=U or higher. If the i parameter of a request response is FALSE, then server 624 may determine that such request should not be loaded incrementally. Thus, when serving requests with u≥U, server 624 may prioritize requests that have i=0 (FALSE) by using an L4S-enabled stream over requests that have i=1 (TRUE), since the latter type of requests can be served while concurrently serving other requests. For requests that have the same u parameter such that u_{c/s}≤V, the server may enable L4S for streams that deliver responses for requests that have incremental parameter i=0 (FALSE). At 646, server 624 may transmit HTTP responses on unidirectional (push) or bidirectional streams, based on the processing at 644.

The parameters u_{c}, i_{c}, uₛ, and/or iₛ may be used for any suitable application, e.g., short-form video prebuffering based on anticipated playout. In some embodiments, system 100 (which may implement process 600) may consider bandwidth in determining an amount of a short-form video that is to be simultaneously pre-buffered to enable faster initial playout when scrolling through a list of videos. For example, a list of videos may be transmitted to client device 612 in an XML metadata file that comprises ABR video URLs for each of the short-form video manifest files along with other metadata such as the posting user, reactions, text/comments, and/or any other suitable metadata, for each short-form video. Bitrate ladder values, which may be included in each short-form video's manifest file, may also be included in the XML metadata, and may also be sent to client device 612 in the metadata file. This may prevent client device 612 from having to retrieve the manifest file for all URLs to determine the bitrates that are available for each short-form video.

To enable an optimally fast playout, both low latency delivery and bandwidth may considered, leveraging the client device 612's u_{c} and i_{c} for each segment request. When the short-form video application displays a recommended list of short-form videos to a user, system 100 may cause a video to begin playing that is in the viewing position centered in the list or as determined by the short-form video viewing system. Multiple ABR players may be presented in the list, where each ABR player may request segments. In some embodiments, only one ABR player will be playing video, and the ABR player chosen by the short-form video system may make a request of the lowest bitrate segment to download a segment with an urgency value of u=0 (highest urgency) and I, and calculate a bandwidth. The currently playing video may also leverage the OTT ABR optimization defined in commonly owned application Ser. No. 18/744,547 referenced above. In such instance, server 624 may at least partially override the choices received from client 612, since server 624 is optimized for playing OTT ABR video. However, client 612 may not be optimized for prebuffering of an initial segment for multiple ABR players to enable very quick playout when a user scrolls or selects a video to play. In the case of the video being short-form video being played, server 624 may choose to override u_{c} and i_{c}. Server 624 may enable or disable the L4S markings based on the size of the fragments, and may still leverage the priority u_{c} value.

Once bandwidth is calculated after the first segment download, and if the user is still watching the video, prebuffering can begin for other ABR players based on a determined value of a video anticipated to be played, available bandwidth value, the bitrate ladders for each of the ABR video players, and/or based on any other suitable data. For any ABR player determined to prebuffer, only one segment may be downloaded for the initial playout, e.g., the buffers may not have to fill. In some embodiments, HTTP requests for the first segment to download can be based on the calculated available bandwidth, and setting the u value may be set appropriately based on its determined priority value in anticipation to be played. During the prebuffering process, requests and/or downloads across the multiple ABR players may be factored in to the overall bandwidth calculation, and, based on bandwidth increasing or decreasing, the number of prebuffering ABR players may increase or decrease along with adjusting the value for each prebuffer request. In some embodiments, the i value is not set for buffering the first segment for each of the ABR players not playing video; the i value may only be set for the player currently playing the ABR video. Handling the priority in such a case allows for control of the bandwidth used when downloading multiple streams, to ensure the currently playing ABR video receives the highest bandwidth allocation in terms of the urgency value.

In some embodiments, server 624 may additionally or alternatively consider file size and/or expected tonnage when determining whether to send a request response on an L4S-enabled stream, in addition to the <u, i> parameters. For example, server 624 may enable L4S on a stream that has an incremental parameter set to FALSE, if the file size is large (e.g., above a threshold, or greater than other portions of the network resource by a certain threshold). By intelligently responding to a network congestion if CE bits are set, server 624 may deliver scalable throughput for a queue-building flow. Thus, by using L4S, server 624 may be able to transmit more data to the client faster.

In some embodiments, server 624 may additionally or alternatively consider interactivity of an element that is rendered at client device 612 while determining whether to send the request response in an L4S-enabled stream. While interactivity of a visual element may often be handled locally at client device 612 once the model has been loaded and rendered, certain types of interactivities may trigger a request back to server 624 or another resource in the cloud that needs computation and delivery of results, or data for rendering as soon as possible. For example, a user is exploring a three-dimensional (3D) space/game that is being rendered perspective-accurate at the client. When the user reaches a checkpoint, such as entry into a new area, or a new level in a game, then a new model/scene may be loaded and executed. In such cases, server 624, being aware of the dependencies on other resources, may send the dynamic, interactive models on bidirectional L4S-enabled streams (or using another preferential network technique). Client device 612 may issue commands back to server 624 over a network on the L4S-enabled stream (or using another preferential network technique), leading to reduced overall latency in computation delivery/rendering.

As another example, server 624 may preload a network/cloud-based-simultaneous localization and mapping (SLAM) spatial map, e.g., used in robotics, drones, self-guided vehicles, XR, and/or other applications. For example, the SLAM system may run locally, but the maps may be stored in the cloud. Each device can update the SLAM map when changes in the maps are identified by the SLAM system running on an XR headset or robotic device. When a robotic device or person wearing an XR headset is moving from an area where the robot or XR device has the spatial map downloaded (e.g., a front yard of a house) to another area (e.g., a front door of the house), it can be anticipated the XR device is about to enter the front door of the house (e.g., which is on the second floor of the house). The house may have three floors, where there is a separate SLAM map for each floor. In this case, u_{c} and i_{c} may be used when requesting the map download. When making the request (e.g., a HTTP/3 request) for the map to be downloaded, the device may request the map of the second floor with a priority value of u=0 and no i flag. The device may also make another request for the download of the first floor with a priority value of u=3 and no i flag. As another example, based on determining (e.g., using historical data for the location) that the upstairs third floor is not visited very often, the request for the third floor map may be made with a priority value u=5 and no i flag.

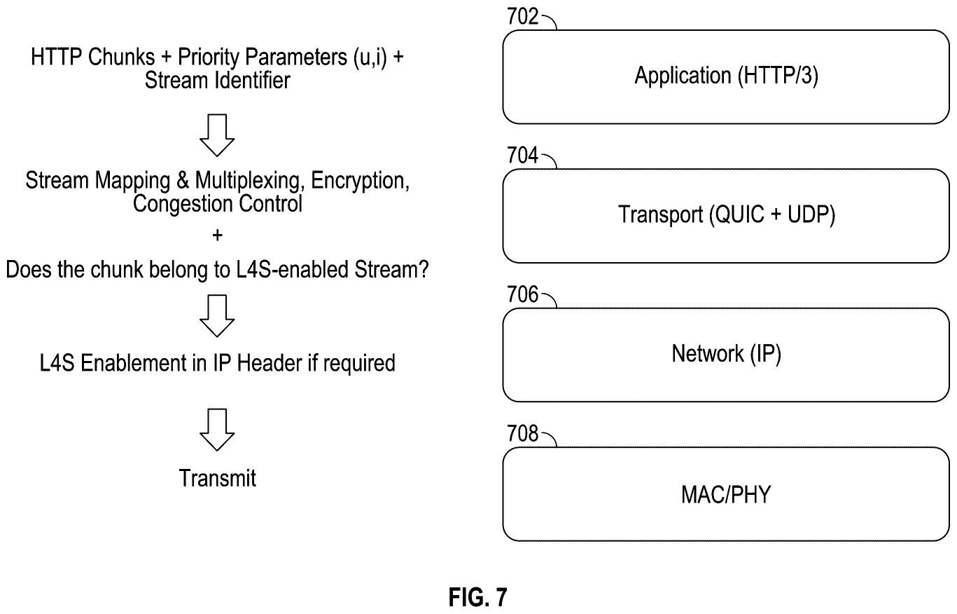

FIG. 7 shows an illustrative block diagram showing different functions performed by various layers in the networking stack of a sender (e.g., a server, such as, for example, server 624 sending HTTPS/3 responses to requests from client device 612), in accordance with some embodiments of this disclosure. At the application layer 702, HTTP chunks are created for a response and passed to transport layer 704 along with the priority parameters (u,i) and a stream identifier, and/or any other suitable parameters. In some embodiments, client device 612 sends an HTTP request on a new stream, using a previously unused stream identifier. Server 624 may send an HTTP response on the same stream as the request. Transport layer 704, which runs QUIC and UDP, performs functions of stream mapping and multiplexing, encryption (e.g., TLS 1.2) and/or congestion control (of each stream). Depending on the stream identifier and its associated priority parameters, this chunk is mapped to an L4S-enabled stream or non-L4S stream. In some embodiments, transport layer 704 then passes the encrypted, multiplexed chunk to the network layer 706, which enables or disables L4S using ECN bits in the IP Header. The IP packet is subsequently translated for sending out on the physical medium 708 (e.g., wired Ethernet, Wi-Fi) by the MAC and PHY functions in the lower layer.

In some embodiments, the techniques described herein may be used to designate portions of code associated with a resource, such as, for example, a JavaScript resource, for prioritized delivery based on the user's behavior and and/or through explicit signaling of prioritization. This may be used, for example, to speed up the loading and execution of larger JavaScript resources, to optimize their applications (e.g., web, mobile, etc.) for speed (e.g., fast initial loading) and responsiveness for an improved user experience. For example, JavaScript code may be split into bundles so that what is needed at page load is loaded first and what is remaining is loaded at a later time (e.g., when a user interacts with an interactive element). Similarly, images and <iframe> elements are bandwidth-intensive, and the system may avoid loading images that are outside the initial viewport (using lazy loading techniques). There are loading attributes that can be added to such images to tell the browser how they should be loaded (e.g., “eager,” “lazy”). Similarly, an iframe (i.e., a separate HTML document with its own sub-resources) may also follow the lazy loading concept.

In some embodiments, the L4S enablement (or other suitable preferential treatment of network traffic) may be for an HTTP range request. Range requests may be used to request a portion of a file, e.g., download managers that allow users to pause/resume downloads to rely on range requests. A download manager can be a download manager for a video game, for example, where users can start playing the game after a portion of the video game has been downloaded. In such case, the systems described herein may prioritize delivery of such portion, e.g., if the user paid to purchase the game. In some embodiments, L4S (or other suitable preferential treatment of network traffic) is enabled for specific user functions (e.g., during the login process), or checkout process (e.g., an eCommerce transaction), refreshing an app to renew a license for content that has been downloaded to a user device (e.g., content has been downloaded and/or not played for a certain number of days), or any other suitable processing, or any combination thereof. Thus, based at least in part on a type of a portion of a network resource, processing and transmittal of such portion of a network resource may be preferential (e.g., using the first queue for L4S traffic).

In some embodiments, the source of the user request, e.g., resources, is requested in response to receiving selection (e.g., clicking or tapping or other suitable selection) of a deep link from a separate app that is not a search engine. Depending on what functions or interactive elements are associated with the deep link, the server may prioritize the delivery of the appropriate resources.

In some embodiments, a new set of priorities can be sent by the client (e.g., client device 612 of FIG. 6) to the server (e.g., server 624 of FIG. 6) at any time using a PRIORITY_UPDATE frame. As discussed in RFC 9218, “PRIORITY_UPDATE frames are sent by clients on the control stream, allowing them to be sent independently of the stream that carries the response. This means they can be used to reprioritize a response or a push stream, or to signal the initial priority of a response instead of the Priority header field.” When the server receives a new set of priorities for a response, this may trigger a change in the value of Boolean ln. Thus, the server may enable or disable L4S while the stream is currently in use. In some examples, the PRIORITY_UPDATE frame can be used by a client to increase the priority of a request response after an unsuccessful attempt (e.g., a timeout). This may trigger enablement of L4S in the response. By deploying L4S for sending the response, the server may improve the chances of delivering the response message on time.

As discussed in RFC 9218, “Generic priority parameters are preferred over vendor-specific, application-specific, or deployment-specific values. If a generic value cannot be agreed upon in the community, the parameter's name should be correspondingly specific (e.g., with a prefix that identifies the vendor, application, or deployment).” For illustration, RFC 9218 further describes that, “[f]or example, if there is a need to provide more granularity than eight urgency levels, it would be possible to subdivide the range using an additional priority parameter. Implementations that do not recognize the parameter can safely continue to use the less granular eight levels.” In some embodiments, new and/or additional priority parameters may be defined by a vendor. In such cases, the vendor may also define a function to map the existing parameters <u, i> and/or new parameters to a Boolean value that determines whether the stream (response) shall be L4S-enabled and/or whether bandwidth may be shared while downloading content.

Websites often display ads for revenue, which are determined via a real-time bidding (RTB) process. In some embodiments, in this bidding, a supply-side platform (SSP) may utilize the techniques described herein to indicate to the demand-side platform (DSP) that, with a new parameter, it can provide stream-prioritized transport for video streams. On that basis, certain brands advertising through a DSP may read the parameter and decide to pay for that prioritization. In some examples, brands may ask for that prioritization via their DSP from the SSP. If there are multiple brands interested in leveraging the stream prioritization, the RTB process may sell the prioritization to the highest payer. In some embodiments, further granularization may be employed, such as, for example, asking for stream prioritization on connected television (CTV) versus social media channels, or other suitable types of content. With knowledge of the Boolean function used to map priorities to L4S-enablement, the website or other network resource may advertise prioritization parameters <u, i> that map to L4S-enablement as premium, while non-L4S <u, i> may be advertised as non-premium.

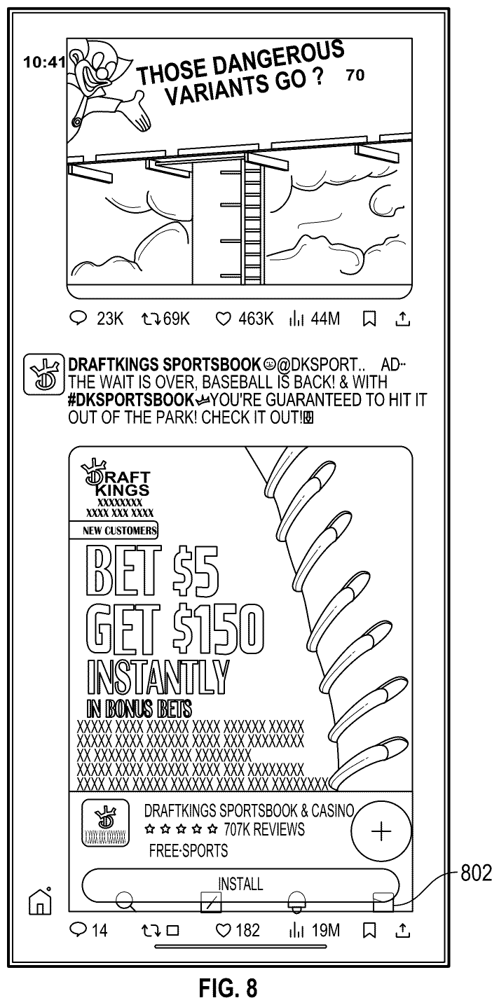

Consumers often hesitate to download new apps on their devices fearing that the download will take a long time, especially during low signal or congested network conditions. As shown in FIG. 8, content providers and/or advertisers may include a “download an app” (call to action) option 802 on social media or other suitable platform (e.g., any suitable software, such as, for example, a video game). The techniques described herein may be utilized to offer stream prioritization to such social media advertising brands so that their apps can be downloaded quickly, e.g., being assigned prioritization relative to other elements in that social media feed, such as downloading images/videos, or other suitable elements. This offer can be priced differently compared to just inserting a basic ad on a social media feed. The advertised prioritization parameters <u, i> for enabling the fast download functionality may be chosen to ensure that the stream is L4S-enabled.

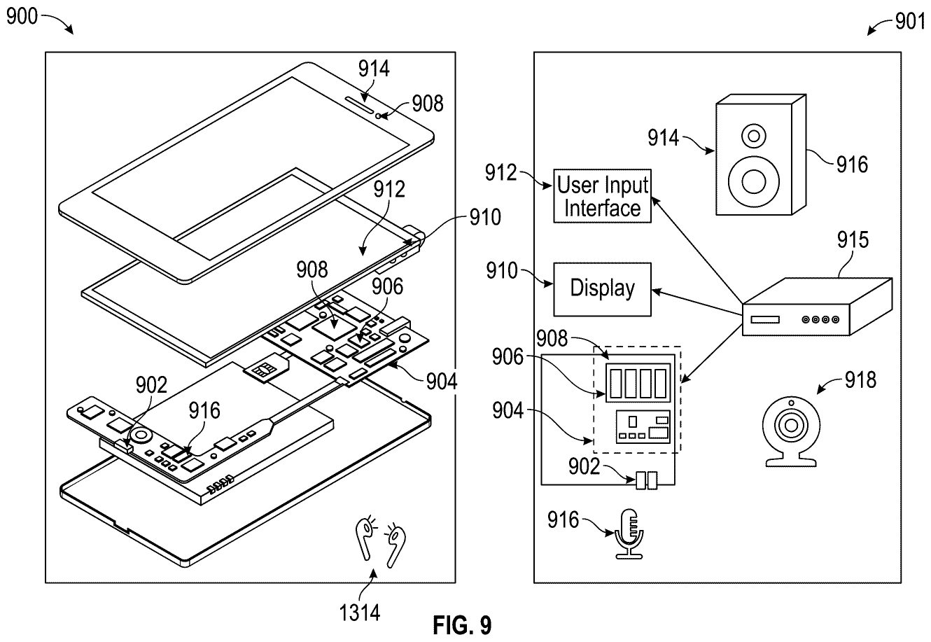

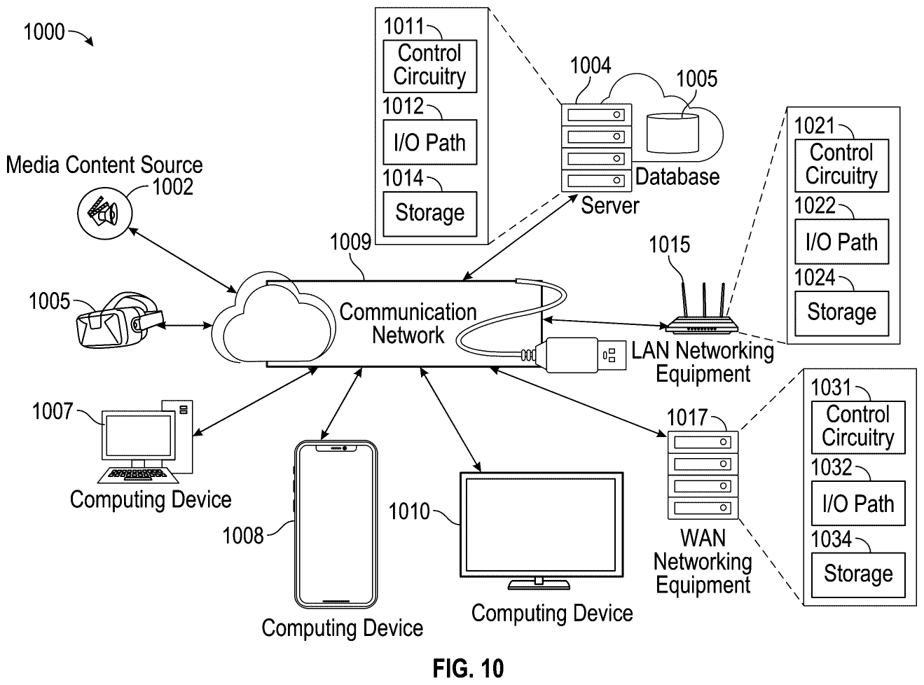

FIGS. 9-10 show illustrative devices, systems, servers, and related hardware for selectively treating portions of network traffic preferentially, in accordance with some embodiments of this disclosure. FIG. 9 shows generalized embodiments of illustrative computing devices 900 and 901, which may correspond to, e.g., a smart phone; a tablet; a laptop computer; a personal computer; a desktop computer; a smart television; a smart watch or wearable device; smart glasses; a stereoscopic display; a wearable camera; virtual reality (VR) glasses; VR goggles; a stereoscopic display; augmented reality (AR) glasses; an AR HMD; a VR HMD; or any other suitable computing device; or any combination thereof. In another example, computing device 901 may be a user television equipment system or device. In some embodiments, computing devices 900 and 901 may correspond to, e.g., device 112 or device 114 of FIG. 1.

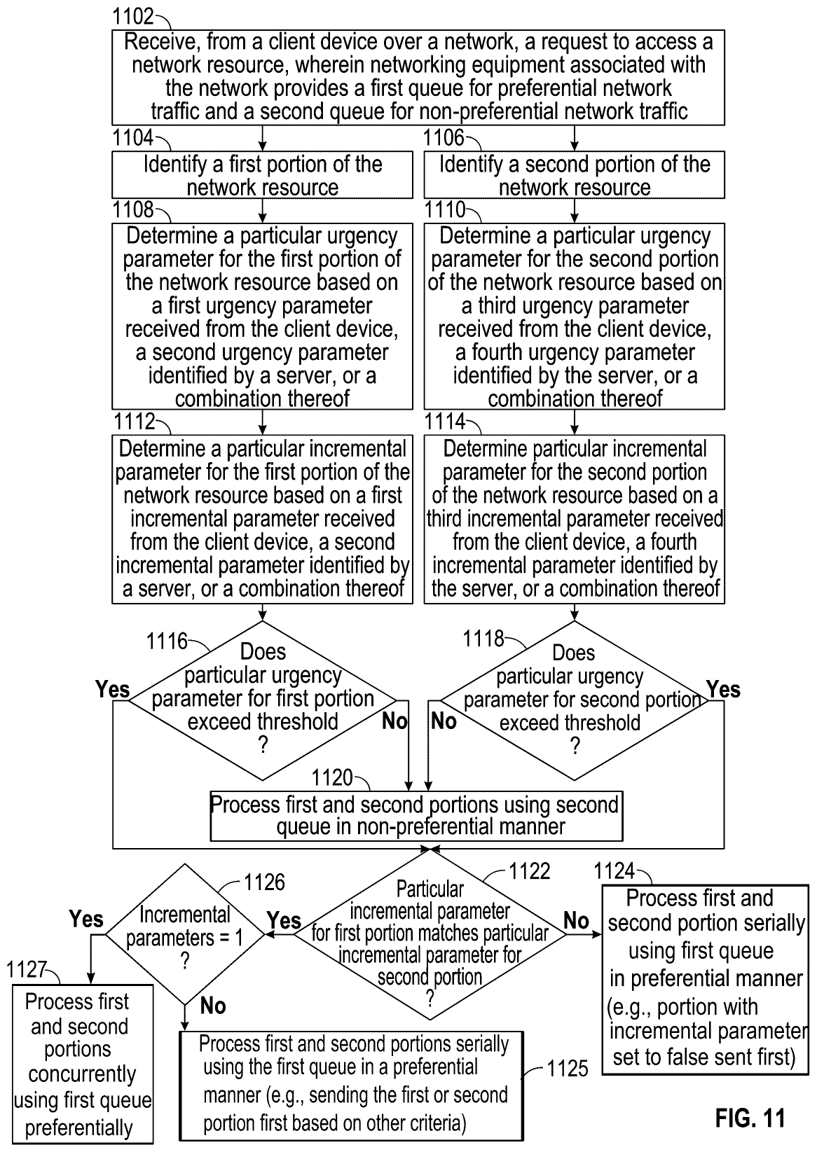

User television equipment device 901 may include set-top box 915. Set-top box 915 may be communicatively connected to microphone 916, Audio output equipment (e.g., speaker or headphones 914), and display 912. In some embodiments, microphone 916 may receive audio corresponding to a voice of a user providing input. In some embodiments, display 1012 may be a television display or a computer display. In some embodiments, set-top box 915 may be communicatively connected to user input interface 910. In some embodiments, user input interface 910 may be a remote control device. Set-top box 915 may include one or more circuit boards. In some embodiments, the circuit boards may include control circuitry, processing circuitry, and storage (e.g., RAM, ROM, hard disk, removable disk, etc.). In some embodiments, the circuit boards may include an input/output path. More specific implementations of computing devices are discussed below in connection with FIG. 11. In some embodiments, computing device 900 may comprise any suitable number of sensors (e.g., gyroscope or accelerometer, etc.), and/or a GPS module (e.g., in communication with one or more servers and/or cell towers and/or satellites) to ascertain a location of computing device 900. In some embodiments, computing device 900 comprises a rechargeable battery that is configured to provide power to the components of the device.

Each one of computing device 900 and computing device 901 may receive content and data via input/output (I/O) path 902. I/O path 902 may provide content (e.g., broadcast programming, on-demand programming, Internet content, content available over a local area network (LAN) or wide area network (WAN), and/or other content) and data to control circuitry 904, which may comprise processing circuitry 906 and storage 908. Control circuitry 1004 may be used to send and receive commands, requests, and other suitable data using I/O path 902, which may comprise I/O circuitry. I/O path 902 may connect control circuitry 904 (and specifically processing circuitry 906) to one or more communications paths (described below). I/O functions may be provided by one or more of these communications paths, but are shown as a single path in FIG. 9 to avoid overcomplicating the drawing. While set-top box 1015 is shown in FIG. 3 for illustration, any suitable computing device having processing circuitry, control circuitry, and storage may be used in accordance with the present disclosure. For example, set-top box 915 may be replaced by, or complemented by, a personal computer (e.g., a notebook, a laptop, a desktop), a smartphone (e.g., computing device 1000), an XR device; a tablet; a network-based server hosting a user-accessible client device; a non-user-owned device; any other suitable device; or any combination thereof.

Control circuitry 904 may be based on any suitable control circuitry such as processing circuitry 906. As referred to herein, control circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 904 executes instructions for the system or application stored in memory (e.g., storage 908). Specifically, control circuitry 904 may be instructed by the system or application to perform the functions discussed above and below. In some implementations, processing or actions performed by control circuitry 904 may be based on instructions received from the system or application.

In client/server-based embodiments, control circuitry 904 may include communications circuitry suitable for communicating with a server or other networks or servers. The system or application may be a stand-alone application implemented on a device or a server. The system or application may be implemented as software or a set of executable instructions. The instructions for performing any of the embodiments discussed herein of the system or application may be encoded on non-transitory computer-readable media (e.g., a hard drive, random-access memory on a DRAM integrated circuit, read-only memory on a BLU-RAY disk, etc.). For example, the instructions may be stored in storage 908, and executed by control circuitry 904 of a computing device 900.

In some embodiments, the system or application may be a client/server application where only the client application resides on device 900 (e.g., device 112 or 114 of FIG. 1), and a server application resides on an external server (e.g., server 1004 of FIG. 10). For example, the system or application may be implemented partially as a client application on control circuitry 904 of device 900 and partially on server 1004 as a server application running on control circuitry 1011. Server 1004 may be a part of a local area network with one or more of computing devices 900, 901 or may be part of a cloud computing environment accessed via the Internet. In a cloud computing environment, various types of computing services for performing searches on the Internet or informational databases, providing video communication capabilities, providing storage (e.g., for a database) or parsing data are provided by a collection of network-accessible computing and storage resources (e.g., server 1004 and/or an edge computing device), referred to as “the cloud.” Device 900 may be a cloud client that relies on the cloud computing capabilities from server 1004 to determine whether processing (e.g., at least a portion of virtual background processing and/or at least a portion of other processing tasks) should be offloaded from the mobile device, and facilitate such offloading. When executed by control circuitry of server 1004, the system or application may instruct control circuitry 1011 to perform processing tasks for the client device and facilitate applying preferential treatment on the WAN to certain network traffic corresponding to data requested by a device on a LAN. The client application may instruct control circuitry 904 to determine where processing should be performed.

Control circuitry 904 may include communications circuitry suitable for communicating with a server, edge computing systems and devices, a table or database server, or other networks or servers The instructions for carrying out the above mentioned functionality may be stored on a server (which is described in more detail in connection with FIG. 10. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communication networks or paths (which is described in more detail in connection with FIG. 10). In addition, communications circuitry may include circuitry that enables peer-to-peer communication of computing devices, or communication of computing devices in locations remote from each other (described in more detail below).

Memory may be an electronic storage device provided as storage 908 that is part of control circuitry 904. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 908 may be used to store various types of content described herein as well as the system or application data described above. Nonvolatile memory may also be used (e.g., to launch a boot-up routine and other instructions). Cloud-based storage, described in more detail in relation to FIG. 12, may be used to supplement storage 908 or instead of storage 908.

Control circuitry 904 may include video generating circuitry and tuning circuitry, such as one or more analog tuners, one or more MPEG-2 decoders or MPEG-2 decoders or decoders or HEVC decoders or any other suitable digital decoding circuitry, high-definition tuners, or any other suitable tuning or video circuits or combinations of such circuits. Encoding circuitry (e.g., for converting over-the-air, analog, or digital signals to MPEG or HEVC or any other suitable signals for storage) may also be provided. Control circuitry 904 may also include scaler circuitry for upconverting and downconverting content into the preferred output format of computing device 900. Control circuitry 904 may also include digital-to-analog converter circuitry and analog-to-digital converter circuitry for converting between digital and analog signals. The tuning and encoding circuitry may be used by computing device 900, 901 to receive and to display, to play, or to record content. The tuning and encoding circuitry may also be used to receive video communication session data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 908 is provided as a separate device from computing device 900, the tuning and encoding circuitry (including multiple tuners) may be associated with storage 908.

Control circuitry 904 may receive instruction from a user by way of user input interface 910. User input interface 910 may be any suitable user interface, such as a remote control, mouse, trackball, keypad, keyboard, touchscreen, touchpad, stylus input, joystick, voice recognition interface, or other user input interfaces. Display 812 may be provided as a stand-alone device or integrated with other elements of each one of computing device 1000 and computing device 901. For example, display 1012 may be a touchscreen or touch-sensitive display. In such circumstances, user input interface 1010 may be integrated with or combined with display 912. In some embodiments, user input interface 1010 includes a remote-control device having one or more microphones, buttons, keypads, any other components configured to receive user input or combinations thereof. For example, user input interface 1010 may include a handheld remote-control device having an alphanumeric keypad and option buttons. In a further example, user input interface 910 may include a handheld remote-control device having a microphone and control circuitry configured to receive and identify voice commands and transmit information to set-top box 915.

Audio output equipment 914 may be integrated with or combined with display 912. Display 912 may be one or more of a monitor, a television, a liquid crystal display (LCD) for a mobile device, amorphous silicon display, low-temperature polysilicon display, electronic ink display, electrophoretic display, active matrix display, electro-wetting display, electro-fluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. A video card or graphics card may generate the output to the display 912. Audio output equipment 1014 may be provided as integrated with other elements of each one of computing device 900 and computing device 901 or may be stand-alone units. An audio component of videos and other content displayed on display 912 may be played through speakers (or headphones) of audio output equipment 914. In some embodiments, audio may be distributed to a receiver (not shown), which processes and outputs the audio via speakers of audio output equipment 914. In some embodiments, for example, control circuitry 904 is configured to provide audio cues to a user, or other audio feedback to a user, using speakers of audio output equipment 914. There may be a separate microphone 916 or audio output equipment 914 may include a microphone configured to receive audio input such as voice commands or speech. For example, a user may speak letters, words, terms and/or numbers that are received by the microphone and converted to text by control circuitry 904. In a further example, a user may voice commands that are received by a microphone and recognized by control circuitry 904. Camera 918 may be any suitable video camera integrated with the equipment or externally connected. Camera 918 may be a digital camera comprising a charge-coupled device (CCD) and/or a complementary metal-oxide semiconductor (CMOS) image sensor. Camera 918 may be an analog camera that converts to digital images via a video card.

The system or application may be implemented using any suitable architecture. For example, it may be a stand-alone application wholly-implemented on each one of computing device 900 and computing device 901. In such an approach, instructions of the application may be stored locally (e.g., in storage 908), and data for use by the application is downloaded on a periodic basis (e.g., from an out-of-band feed, from an Internet resource, or using another suitable approach). Control circuitry 904 may retrieve instructions of the application from storage 908 and process the instructions to provide the functionality, and generate any of the displays, discussed herein. Based on the processed instructions, control circuitry 904 may determine what action to perform when input is received from user input interface 910. For example, movement of a cursor on a display up/down may be indicated by the processed instructions when user input interface 910 indicates that an up/down button was selected. An application and/or any instructions for performing any of the embodiments discussed herein may be encoded on computer-readable media. Computer-readable media includes any media capable of storing data. The computer-readable media may be non-transitory including, but not limited to, volatile and non-volatile computer memory or storage devices such as a hard disk, floppy disk, USB drive, DVD, CD, media card, register memory, processor cache, Random Access Memory (RAM), etc.

Control circuitry 904 may allow a user to provide user profile information or may automatically compile user profile information. For example, control circuitry 904 may access and monitor network data, video data, audio data, processing data, historical interactions by the user, and/or any other suitable data. Control circuitry 904 may obtain all or part of other user profiles that are related to a particular user (e.g., via social media networks), and/or obtain information about the user from other sources that control circuitry 904 may access. As a result, a user can be provided with a unified experience across the user's different devices.

In some embodiments, the system or application is a client/server-based application. Data for use by a thick or thin client implemented on each one of computing device 900 and computing device 901 may be retrieved on-demand by issuing requests to a server remote to each one of computing device 900 and computing device 901. For example, the remote server may store the instructions for the application in a storage device. The remote server may process the stored instructions using circuitry (e.g., control circuitry 904) and generate the displays discussed above and below. The client device may receive the displays generated by the remote server and may display the content of the displays locally on computing device 1000. This way, the processing of the instructions is performed remotely by the server while the resulting displays (e.g., that may include text, a keyboard, or other visuals) are provided locally on computing device 900. Computing device 900 may receive inputs from the user via input interface 310 and transmit those inputs to the remote server for processing and generating the corresponding displays. For example, computing device 900 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to computing device 900 for presentation to the user.

In some embodiments, the system or application may be downloaded and interpreted or otherwise run by an interpreter or virtual machine (run by control circuitry 1004). In some embodiments, system or application may be encoded in the ETV Binary Interchange Format (EBIF), received by control circuitry 904 as part of a suitable feed, and interpreted by a user agent running on control circuitry 904. For example, the system or application may be an EBIF application. In some embodiments, the system or application may be defined by a series of JAVA-based files that are received and run by a local virtual machine or other suitable middleware executed by control circuitry 904. In some of such embodiments (e.g., those employing MPEG-2, MPEG-4, HEVC or any other suitable digital media encoding schemes), the system or application may be, for example, encoded and transmitted in an MPEG-2 object carousel with the MPEG audio and video packets of a program.

FIG. 10 is a diagram of an illustrative system 1000 for treating portions of a network resource preferentially, in accordance with some embodiments of this disclosure. Computing devices 1005, 1007, 1008, 1010 (which may correspond to, e.g., computing device 900 or 901) may be coupled to communication network 1009. Communication network 1009 may be one or more networks including the Internet, a mobile phone network, mobile voice or data network (e.g., a 5G, 4G, or LTE network), cable network, public switched telephone network, satellite network, or other types of communication network or combinations of communication networks. Paths (e.g., depicted as arrows connecting the respective devices to the communication network 1009) may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Communications with the client devices may be provided by one or more of these communications paths but are shown as a single path in FIG. 12 to avoid overcomplicating the drawing. In some embodiments, communication network 1009 may correspond to service provider network 102.

LAN networking equipment 1015 may correspond to, for example, networking equipment 106 and/or 108 (e.g., router, gateway, switch, and/or modem and/or other suitable equipment) of FIG. 1. LAN networking equipment 1015 may comprise control circuitry 1021, I/O path 1022, and storage 1024. WAN networking equipment 1017 may correspond to, for example, networking equipment 122 (e.g., a backbone or carrier router or CMTS other suitable networking equipment) of FIG. 1. WAN networking equipment 1017 may comprise control circuitry 1031, I/O path 1032, and storage 1034.

Although communications paths are not drawn between computing devices, these devices may communicate directly with each other via communications paths as well as other short-range, point-to-point communications paths, such as USB cables, IEEE 1394 cables, wireless paths (e.g., Bluetooth, infrared, IEEE 702-11x, etc.), or other short-range communication via wired or wireless paths. The computing devices may also communicate with each other directly through an indirect path via communication network 1009.

System 1000 may comprise media content source 1002, one or more servers 1004, and/or one or more edge computing devices. In some embodiments, system or application may be executed at one or more of control circuitry 1011 of server 1004 (and/or control circuitry of computing devices 1005, 1007, 1008, 1010 and/or control circuitry of one or more edge computing devices). In some embodiments, media content source 1002 and/or server 1004 may be configured to facilitate network traffic between computing devices 1005, 1007, 1008, 1010 and/or any other suitable computing devices, and/or host or otherwise be in communication (e.g., over network 1009) with one or more application services. In some embodiments, server 1004 may perform actions to facilitate processing network traffic based on received user input as described herein.

In some embodiments, server 1004 may include control circuitry 1011 and storage 1014 (e.g., RAM, ROM, Hard Disk, Removable Disk, etc.). Storage 1014 may store one or more databases. Server 1004 may also include an input/output path 1012. I/O path 1012 may provide network traffic information, user preferences, device information, or other data, over a LAN or WAN, and/or other content and data to control circuitry 1011, which may include processing circuitry, and storage 1014. Control circuitry 1011 may be used to send and receive commands, requests, and other suitable data using I/O path 1012, which may comprise I/O circuitry. I/O path 1012 may connect control circuitry 1011 (and specifically control circuitry) to one or more communications paths.

Control circuitry 1011 may be based on any suitable control circuitry such as one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, control circuitry 1011 may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 1011 executes instructions for an emulation system application stored in memory (e.g., the storage 1014). Memory may be an electronic storage device provided as storage 1014 that is part of control circuitry 1011.

FIG. 11 is a flowchart of a detailed illustrative process 1100 for preferential treatment of portions of network traffic, in accordance with some embodiments of this disclosure. In various embodiments, the individual steps of process 1100 may be implemented by one or more components of the devices, methods, and systems of FIGS. 1-10 and may be performed in combination with any of the other processes and aspects described herein. Although the present disclosure may describe certain steps of process 1100 (and of other processes described herein) as being implemented by certain components of the devices, methods, and systems of FIGS. 1-10, this is for purposes of illustration only, and it should be understood that other components of the devices, methods, and systems of FIGS. 1-10 may implement those steps instead.

At 1102, control circuitry (e.g., control circuitry 904 of device 900 or 901 of FIG. 9 and/or control circuitry 1010 of server 1004) may receive, from a client device (e.g., device 112 of FIG. 1), a request to access a network resource (e.g., network resource 500 of FIG. 5). The request may be received during a network session transmitted over a network from one or more servers and/or databases to one or more devices. In some embodiments, the network may correspond to an LAN and/or WAN and/or any other suitable network (e.g., communications network 1009 of FIG. 10). In some embodiments, the network session may be established automatically or based on a request received from the device. Such request may be received from, for example, a device (e.g., device 112 or 114 of FIG. 1). In some embodiments, the device may be connected to an LAN (e.g., a Wi-Fi network) at a particular location (e.g., location 104 of FIG. 1, which may be a home or residence of user 110 or any other suitable type of location). For example, router, modem, and/or gateway 106 and/or 108 may be used to provide such LAN, to enable the devices to connect to the Internet and access any suitable application or service.

Control circuitry (e.g., 1021 of LAN networking equipment 1015 and/or 1031 of WAN networking equipment 1017) provides a first queue for preferential network traffic and a second queue for non-preferential traffic. For example, the first queue may comprise a buffer for a low latency service flow (e.g., 206, 210, 218 of FIGS. 2A-2B), such as, for example, for L4S-capable traffic, and the second queue may comprise a buffer for a classic service flow (e.g., service flow 208, 212, and/or 220 of FIGS. 2A-2B), such as, for example, for non-L4S-capable traffic.

At 1104, the control circuitry may identify a first portion of a network resource (e.g., video 504 of a college football game provided via website 502 of FIG. 5). At 1106, the control circuitry may identify a second portion of a network resource (e.g., advertisement 510 of FIG. 5). The control circuitry may identify any suitable number of portions of a network resource, e.g., sports box scores 508, chat function 506, audio 505 of the college football game, of network resource 500. The server may provide indications to the client of such portions of the network resource, and/or the client may parse received data regarding such portions of the network resource.

At 1108, the control circuitry may determine a particular urgency parameter for the first portion of network traffic (e.g., video 504 of a college football game provided via website 502 of FIG. 5). Such particular urgency parameter may be determined based on a first urgency parameter for the first portion of the network resource received from the client device, e.g., u_{c}; a second urgency parameter for the first portion of the network resource received from the client device, e.g., uₛ, or any suitable combination thereof. For example, control circuitry of the server may ignore the urgency parameter received from the client and use its own determined urgency parameter, or use the urgency parameter received from the client device, or blend the urgency parameters u_{c} and uₛ to obtain the particular urgency parameter for the first portion of network traffic.

At 1110, the control circuitry may determine a particular urgency parameter for the second portion of network traffic (e.g., advertisement 510 of FIG. 5). Such particular urgency parameter may be determined based on a second urgency parameter for the second portion of the network resource received from the client device, e.g., u_{c}; a second urgency parameter for the second portion of the network resource received from the client device, e.g., uₛ, or any suitable combination thereof. For example, control circuitry of the server may ignore the urgency parameter received from the client and use its own determined urgency parameter, or use the urgency parameter received from the client device, or blend the urgency parameters u_{c} and uₛ to obtain the particular urgency parameter for the second portion of network traffic.

In some embodiments, client device 612 and/or server 624 may take into account a main purpose of the network resource (e.g., to watch a live college football game or highlights of a college football game), and thus video portion 504 may be given the lowest urgency parameter value of each portion of network resource 500 (causing video portion 504 content to be processed using a first queue for low latency traffic), followed by audio portion 505 of the college football game or highlights. In some embodiments, client device 612 and/or server 624 may take into account preferences of the user (e.g., user 110) accessing network resource 500, preferences of users generally, popularity of certain portions (e.g., Taylor Swift in advertisement 510), preferences of content providers (e.g., an advertiser may pay extra to a website to have their advertisements prioritized, such as advertiser 510), and/or any other suitable criteria, in determining urgency values to be assigned to different portions of network resource 500

At 1112, the control circuitry may determine a particular incremental parameter for the first portion of network traffic (e.g., video 504 of a college football game provided via website 502 of FIG. 5). Such particular incremental parameter may be determined based on a first incremental parameter for the first portion of the network resource received from the client device, e.g., i_{c}; a second incremental parameter for the first portion of the network resource received from the client device, e.g., is; or any suitable combination thereof. For example, control circuitry of the server may ignore the incremental parameter received from the client and use its own determined incremental parameter, or use the incremental parameter received from the client device, or blend the incremental parameters i_{c} and is to obtain the particular incremental parameter for the first portion of network traffic.

At 1114, the control circuitry may determine a particular incremental parameter for the second portion of network traffic (e.g., advertisement 510 of FIG. 5). Such particular incremental parameter may be determined based on a third incremental parameter for the second portion of the network resource received from the client device, e.g., i_{c}; a fourth incremental parameter for the second portion of the network resource received from the client device, e.g., is; or any suitable combination thereof. For example, control circuitry of the server may ignore the incremental parameter received from the client and use its own determined incremental parameter, or use the incremental parameter received from the client device, or blend the incremental parameters i_{c} and is to obtain the particular incremental parameter for the second portion of network traffic.

The urgency parameter and the incremental parameter may be included in a priority parameter for a particular portion of a network resource. RFC 9218 states that “[t]he incremental (i) parameter value is Boolean . . . . It indicates if an HTTP response can be processed incrementally, i.e., provide some meaningful output as chunks of the response arrive. The default value of the incremental parameter is false (0). If a client makes concurrent requests with the incremental parameter set to false, there is no benefit in serving responses with the same urgency concurrently because the client is not going to process those responses incrementally. Serving non-incremental responses with the same urgency one by one, in the order in which those requests were generated, is considered to be the best strategy. If a client makes concurrent requests with the incremental parameter set to true, serving requests with the same urgency concurrently might be beneficial.

At 1116, the control circuitry may determine whether the particular urgency parameter obtained for the first portion at 1112 exceeds a threshold. At 1118, the control circuitry may determine whether the particular urgency parameter obtained for the second portion at 1114 exceeds a threshold. In some embodiments, 1116 and 1118 may additionally or alternatively comprise comparing u_{c} and/or uₛ to one or more thresholds. If the particular urgency parameter Ules is less than or equal to a threshold I′, then In is TRUE (since a lower value corresponds to a higher urgency). On the other hand, if urgency parameter u_{c/s} is greater than a threshold V, then lₙ is FALSE. In some embodiments, threshold parameter I′ may be implementation-dependent, or may be default value, and/or may be set to 0, 1 or 2. A negative determination at 1116 may cause processing to proceed to 1120, where the first portion of the network resource may be processed non-preferentially using the second queue. Similarly, a negative determination at 1118 may cause processing to proceed to 1120, where the second portion of the network resource may be processed non-preferentially using the second queue.

At 1122, having determined that one or more of the particular urgency value for the first portion of the network resource or the particular urgency value for the second portion of the network resource exceeds the threshold, the control circuitry may determine whether the particular incremental parameter for the first portion of the network resource matches the particular incremental parameter for the second portion of the network resource. In some embodiments, affirmative determinations at 1116 and 1118 may cause processing to proceed to 1124 directly, where the portions having a particular urgency parameter exceeding the threshold may be processed preferentially when transmitted over the network using the first queue. A negative determination at 1122 may cause processing to proceed to 1124. L4S, or another suitable technique for treating certain portions of a network resource preferentially, may be utilized at 1124, to process the first and second portions serially using the first queue, i.e., in a preferential manner. The priority parameters may be correlated with ECN bits of L4S, for example. In some embodiments, at 1124, the portion from among the first and second portions having its particular incremental parameter set to false (e.g., indicating the portion cannot be processed incrementally) may be transmitted to the client device first, and the portion from among the first and second portions having its particular incremental parameter set to true may subsequently be transmitted to the client device.

L4S enablement on a packet occurs by marking the ECN bits in the packet IP header. For example, an ECT(1) marking indicates that the sender is capable of L4S transport. If a network element experiences congestion, it converts the 2-bit ECN marking from ECT(1) to CE. The markings are echoed back to the sender in acknowledgements from the receiver. The sender then reduces throughput in scalable manner. An ECN-capable AQM marks a packet as CE instead of dropping it when congestion is detected, with a considerable packet loss reduction but less significant latency reduction compared to a packet-dropping AQM. L4S is an evolution of ECN where one of the ECN codepoints, ECT(1), is devoted to L4S.

At 1126, upon determining that the particular incremental parameter for the first portion of the network resource matches the particular incremental parameter for the second portion of the network resource, the control circuitry may determine whether the incremental parameters are equal to 1, e.g., indicating the portion can be loaded incrementally, and if so, processing may proceed to 1127. On the other hand, if the incremental parameters are equal to zero, processing may proceed to 1125, since a false value does not permit sharing of bandwidth.

At 1125, having determined the incremental parameters are set to false for the first and second portions having the matching urgency value, the control circuitry may process the first and second portions serially using the first queue in a preferential manner. For example, the control circuitry may use any suitable criteria (e.g., file size, expected tonnage, user preferences, network bandwidth, and/or any other suitable criteria or system logic) to determine which of the first or second portions should be transmitted first to the client device. At 1127, having determined that the incremental parameters are set to true for the first and second portions having the matching urgency value, the control circuitry may process the first and second portions concurrently/in parallel using the first queue to treat such traffic in a preferential manner, when transmitting the first and second portion to a client device.

In some embodiments, application service providers may provide the implementation of the function where the server or client makes the choice to enable L4S based on the urgency level and the incremental flag. Combining the optimization from HTTP/3 leveraging the client and server set urgency value and the incremental flag to be given to an implementation of a decision function as defined by an application service provider can offer improvements in optimizing HTTP/3 web-based traffic for almost all web-based applications.

The processes discussed above are intended to be illustrative and not limiting. One skilled in the art would appreciate that the steps of the processes discussed herein may be omitted, modified, combined and/or rearranged, and any additional steps may be performed without departing from the scope of the invention. More generally, the above disclosure is meant to be illustrative and not limiting. Only the claims that follow are meant to set bounds as to what the present invention includes. Furthermore, it should be noted that the features described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A computer-implemented method, comprising:
receiving, from a client device over a network, a first urgency parameter in relation to a first portion of a network resource, wherein networking equipment associated with the network provides a first queue for preferential network traffic and a second queue for non-preferential network traffic;
identifying, by a server, a second urgency parameter in relation to the first portion of the network resource;
based on at least one of the first urgency parameter or the second urgency parameter, determining whether to transmit the first portion to the client device over the network using the first queue or the second queue; and
based on the determining, causing the first portion of the network resource to be transmitted preferentially to the client device over the network using the first queue instead of the second queue.

2. The computer-implemented method of claim 1, further comprising:
receiving, from the client device over the network, a third urgency parameter in relation to a second portion of the network resource;
identifying, by the server, a fourth urgency parameter in relation to the second portion of the network resource;
based on at least one of the third urgency parameter or the fourth urgency parameter, determining whether to transmit the second portion to the client device over the network using the first queue or the second queue; and
based on the determining, causing the second portion of the network resource to be transmitted non-preferentially to the client device over the network using the second queue instead of the first queue.

3. The computer-implemented method of claim 1, wherein the first urgency parameter corresponds to the second urgency parameter.

4. The computer-implemented method of claim 1, wherein the determining whether to transmit the first portion preferentially or non-preferentially to the client device over the network is based on the second urgency parameter and is not based on the first urgency parameter.

5. The computer-implemented method of claim 1, wherein the determining whether to transmit the first portion preferentially or non-preferentially to the client device over the network is based on a combination of the first urgency parameter and the second urgency parameter.

6. The computer-implemented method of claim 1, further comprising:
selecting, as a particular urgency parameter for the first portion of the network resource, the first urgency parameter, the second urgency parameter, or an urgency parameter obtained based on the first urgency parameter and the second urgency parameter;
wherein the determining whether to transmit the first portion preferentially or non-preferentially to the client device over a network is based on comparing a value of the particular urgency parameter of the first portion to a threshold.

7. The computer-implemented method of claim 1, further comprising:
receiving, from the client device and in relation to the first portion of the network resource, a first incremental parameter; and
identifying, by the server and in relation to the first portion of the network resource, a second incremental parameter;
wherein the determining whether to transmit the first portion preferentially or non-preferentially to the client device over the network is further based on at least one of the first incremental parameter or the second incremental parameter, wherein a first priority parameter comprises the first urgency parameter and the first incremental parameter, wherein a second priority parameter comprises the second urgency parameter and the second incremental parameter, and wherein each of the first and second incremental parameters is a Boolean value.

8. The computer-implemented method of claim 2, further comprising:
selecting, as a particular urgency parameter for the first portion of the network resource, the first urgency parameter, the second urgency parameter, or an urgency parameter obtained based on the first urgency parameter and the second urgency parameter;
selecting, as a particular urgency parameter for the second portion of the network resource, the third urgency parameter, the fourth urgency parameter, or an urgency parameter obtained based on the third urgency parameter and the fourth urgency parameter; and
based on determining that the particular urgency parameter for the first portion of the network resource matches the particular urgency parameter for the second portion of the network resource, causing the determination of whether to transmit the first portion preferentially or non-preferentially to the client device over the network to be further based on at least one of a first incremental parameter or a second incremental parameter for the first portion.

9. The computer-implemented method of claim 1, wherein the first urgency parameter is an HTTP urgency parameter for retrieving an HTML document, an XML document, a JavaScript resource, or any combination thereof, corresponding to the network resource.

10. The computer-implemented method of claim 1, wherein causing the first portion of the network resource to be transmitted preferentially to the client device over the network using the first queue instead of the second queue is based at least in part on a file size or expected tonnage associated with the first portion of the network resource.

11. The computer-implemented method of claim 1, wherein the network resource comprises a plurality of portions including a plurality of short-form videos, the method further comprising:
selecting, as a particular urgency parameter for the first portion of the network resource, the first urgency parameter, the second urgency parameter, or an urgency parameter obtained based on the first urgency parameter and the second urgency parameter;
while a particular short-form video of the plurality of short-form videos corresponding to the first portion is being played at the client device, setting the particular urgency parameter for the particular short-form video higher than a plurality of urgency parameters for the other of the plurality of short-form videos;
prebuffering the plurality of short-form videos based at least in part on the plurality of urgency parameters; and
based on current network conditions, adjusting one or more of the plurality of urgency parameters.

12. The computer-implemented method of claim 1, further comprising:
selecting, as a particular urgency parameter for the first portion of the network resource, the first urgency parameter, the second urgency parameter, or an urgency parameter obtained based on the first urgency parameter and the second urgency parameter; and
setting the particular urgency parameter for the first portion of the network resource based at least in part on a location of the client device in relation to a plurality of locations proximate to the location of the client device.

13. The computer-implemented method of claim 1, further comprising:
causing the first portion of the network resource to be transmitted preferentially to the client device over the network using the first queue instead of the second queue based on a type of the first portion of the network resource.

14. The computer-implemented method of claim 1, further comprising:
based on determining that an attempt to transmit the first portion of the network resource was unsuccessful, increasing a value of at least one of the first urgency parameter or the second urgency parameter for the first portion for a subsequent attempt to transmit the first portion to the client device.

15. The computer-implemented method of claim 1, wherein the first portion comprises an advertisement, and a value of at least one of the first urgency parameter or the second urgency parameter for the first portion for the advertisement is increased based on an indication received from a provider of the advertisement.

16. The computer-implemented method of claim 1, wherein the first portion comprises an application available for download, and a value of at least one of the first urgency parameter or the second urgency parameter for the first portion for the application available for download is increased based on an indication received from a provider of the application.

17. A system, comprising:
control circuitry configured to:
receive, from a client device over a network, a first urgency parameter in relation to a first portion of a network resource, wherein networking equipment associated with the network provides a first queue for preferential network traffic and a second queue for non-preferential network traffic;
identify, by a server, a second urgency parameter in relation to the first portion of the network resource;
based on at least one of the first urgency parameter or the second urgency parameter, determine whether to transmit the first portion to the client device over the network using the first queue or the second queue; and
based on the determining, cause the first portion of the network resource to be transmitted preferentially to the client device over the network using the first queue instead of the second queue.

18. The system of claim 17, wherein the control circuitry is further configured to:
receive, from the client device over the network, a third urgency parameter in relation to a second portion of the network resource;
identify, by the server, a fourth urgency parameter in relation to the second portion of the network resource;
based on at least one of the third urgency parameter or the fourth urgency parameter, determine whether to transmit the second portion to the client device over the network using the first queue or the second queue; and
based on the determining, cause the second portion of the network resource to be transmitted non-preferentially to the client device over the network using the second queue instead of the first queue.

19. The system of claim 17, wherein the first urgency parameter corresponds to the second urgency parameter.

20. The system of claim 17, wherein the control circuitry is further configured to determine whether to transmit the first portion preferentially or non-preferentially to the client device over the network based on the second urgency parameter and not based on the first urgency parameter.

21-80. (canceled)
